(19) United States
(12) Patent Application Publication
(10) Pub. No.: US 2007/0281574 A1
(43) Pub. Date: Dec. 6, 2007

(54) METHOD FOR MANUFACTURING ELECTROLUMINESCENT MATERIAL

(75) Inventors: Hiroki OHARA, Koza (JP); Yoshiharu HIRAKATA, Ebina (JP)

Correspondence Address: FISH & RICHARDSON P.C., P.O. BOX 1022, MINNEAPOLIS, MN, 55440-1022, US

(73) Assignee: SEMICONDUCTOR ENERGY LABORATORY CO., LTD., Atsugi-shi (JP)

(21) Appl. No.: 11/753,688

(22) Filed: May 25, 2007

(30) Foreign Application Priority Data
Jun. 1, 2006 (JP) 2006-153228

(51) Int. Cl. H01J 9/00

(52) U.S. Cl. 445/24

(57) ABSTRACT

The present invention provides a manufacturing method of an inorganic EL material with high safety, in which the number of steps is reduced, in order to improve emission luminance, efficiency, or life time as compared with a conventional material. The present invention provides a manufacturing method of an inorganic EL material, in a case where a material is used, which is a necessary element or compound for synthesis of the inorganic EL material but includes an element to be unnecessary for the light-emission mechanism. Further, it is an object to provide a light-emitting device and an electronic device using the thusly synthesized inorganic material. In the present invention, a plurality of materials each of which vapor pressure is different are separately disposed in a sealed-tube container, and baking by heating are performed so that at least one of the materials is evaporated, whereby an electroluminescent material is manufactured by baking.

### BACKGROUND OF THE INVENTION

1. Field of the Invention

The present invention relates to a material for forming a light-emitting element, and particularly relates to a method for making an inorganic electroluminescent material.

2. Description of the Related Art

In recent years, a display device in a television set, a mobile phone, a digital camera, or the like has been required to be flat and thin, and a display device utilizing a self-luminous light-emitting element has attracted attention as a display device for meeting this requirement. A light-emitting element utilizing electroluminescence (hereinafter, also described as EL) is given as one of the self-luminous light-emitting elements. In this light-emitting element, a light-emitting material is interposed between a pair of electrodes and light emission from the light-emitting material can be obtained by applying a voltage.

Such a self-luminous light-emitting element has advantages that visibility of a pixel is high in comparison with a liquid crystal display and that a backlight is not required. Therefore, it is considered that the self-luminous light-emitting element is suitable as a flat panel display element. In addition, such a light-emitting element can be manufactured to be thin and light, which is a big advantage. Moreover, the light-emitting element has a feature that response speed is extremely fast.

Furthermore, since such a self-luminous light-emitting element can be formed into a film form, plane emission can be easily obtained by formation of a large-area element. This characteristic is difficult to be obtained by a point light source typified by an incandescent lamp or an LED (Light Emitting Diode), or a line light source typified by a fluorescent lamp. Therefore, the light-emitting element has a high utility value as a surface light source that can be applied to lighting or the like.

A light-emitting element utilizing electroluminescence is classified by whether a light-emitting material is an organic compound or an inorganic compound. In general, the former is referred to as an organic EL element and the latter is referred to as an inorganic EL element.

The inorganic EL element is classified into a dispersion type inorganic EL element and a thin film type inorganic EL element, depending on its element structure. The former and the latter are different in that the former has a light-emitting layer in which particles of a light-emitting material are dispersed, whereas the latter has a light-emitting layer formed of a thin film of a fluorescent material. However, the mechanism of both elements is common, and light emission can be obtained by collision excitation of a base material or a luminescent center due to accelerated electrons in a high electric field. Therefore, in order to obtain light emission from the general inorganic EL element, a high electric filed is needed, and several hundred volts are needed to be applied to the light-emitting element. For example, an inorganic EL element emitting blue light with high luminance which is needed for a full color display has been recently developed, and a driving voltage of 100 to 200 V is needed (for example, Non Patent Document: Japanese Journal of Applied Physics, 1999, Vol. 38, pp. L1291-L1292). Therefore, the inorganic EL element has high power consumption and has been difficult to be applied to a medium or small-sized display, for example, a display of a mobile phone or the like.

Conventionally, when a light-emitting material in the inorganic EL element is synthesized, a base material has been mixed with a material including an impurity element that is to be a luminescent center (added as an activator) or a fluorescent material and been baked in the case of baking with the electric furnace. However, in such a case, the base material itself is decomposed when baking at a high temperature is conducted, and a material having a defect may be manufactured after the baking. There is a problem in that such a defect may give adverse effect to characteristics such as emission luminance of an inorganic EL element.

As for a solution of the above problem, a method is proposed, in which a crucible for an atmosphere gas material is provided above a fluorescent material (for example, see Patent Document 1: Japanese Published Patent Application No. H6-192655). However, in this method, the atmosphere is made using a material with an extremely low boiling point such as carbon disulfide (CS₂). Furthermore, a flash point and an ignition point of the carbon disulfide are respectively −30° C. and 100° C., which are extremely low. Therefore, carbon disulfide is easily evaporated, and when it is mixed with air, carbon disulfide becomes an explosive mixture gas. Accordingly, work and handling of the material becomes increasingly dangerous.

An inorganic EL material used in an inorganic EL element, particularly, a light-emitting material is sensitive to an impurity, and, when an impurity exits, which does not relate to the light-emission mechanism other than an impurity to be a luminescent center in a base material, characteristics of the light-emitting material is degraded. When the light-emitting material is synthesized by baking, a material may be used, which includes an element that is necessary for synthesis but is not desired to be included in a base material. However, in the conventionally known synthesis method of the light-emitting material, all necessary materials are together mixed and baked at an appropriate temperature. Accordingly, in such a case, washing is needed to be performed in order to remove an impurity and an unreacted material that are unnecessary after baking, and a by-product material. A washing method is used in different ways depending on a substance to be removed, and washing using pure water, acid washing, base washing, or the like may be needed in some cases. In such cases, a solution is used during the washing, and therefore, drying is lastly needed.

### SUMMARY OF THE INVENTION

In the view of the above problem, it is an object of the present invention to provide a manufacturing method of an electroluminescent material of which emission luminance, emission efficiency, and life time are improved as compared with a conventional material. In addition, it is an object of the present invention to provide a manufacturing method of an electroluminescent material with high safety, in which the number of manufacturing steps is reduced. Further, it is an object to provide a manufacturing method of an electroluminescent material utilizing a material including an element that is necessary for synthesis of the electroluminescent material but is to be an impurity to a light-emission mechanism. Furthermore, it is also an object to provide a light-emitting device and an electronic device utilizing an electroluminescent material synthesized in such a manner.

In the present invention, a plurality of materials each of which vapor pressure is different are separately disposed in a sealed-tube container, and baking by heating are performed so that at least one of the materials is evaporated, whereby an electroluminescent material is manufactured by baking.

One mode of the present invention is a manufacturing method of an electroluminescent material including steps of disposing a first material contained in a first crucible and a second material contained in a second crucible in a reaction container, the second material being to be gas in the reaction container when baking; reducing pressure in the reaction container; sealing the reaction container hermetically in a state where the reduced pressure is held in the reaction container; and baking the first material while the second material is evaporated by application of heat to the reaction container which has been hermetically sealed.

Another mode of the present invention is a manufacturing method of an electroluminescent material including the steps of disposing a first material contained in a first region and a second material contained in a second region, in a reaction container including the first region and the second region that are separated by an orifice, the second material being to be gas in the reaction container when baking; reducing pressure in the reaction container; sealing the reaction container hermetically in a state where the reduced pressure is held; and baking the first material while the second material is evaporated by application of heat to the reaction container which has been sealed hermetically.

According to the present invention, an impurity giving adverse effect to light-emitting characteristics of an electroluminescent material can be reduced as much as possible, whereby emission luminance, emission efficiency, and life time can be improved as compared with a conventional material. In addition, when an electroluminescent material is manufactured by the present invention, the number of steps for operation can be reduced and the safety can be ensured.

### BRIEF DESCRIPTION OF DRAWINGS

FIGS. 1A to 1D are views explaining a method in which an inorganic EL material of the present invention is baked using a sealed tube.

FIGS. 2A to 2C are views explaining a method in which an inorganic EL material of the present invention is baked using an open tube.

FIGS. 3A and 3B are views explaining a method in which an inorganic EL material of the present invention is baked using a sealed tube.

FIGS. 4A to 4C are views each explaining a light-emitting element of the present invention.

FIGS. 5A and 5B are views explaining a light-emitting device of the present invention.

FIGS. 6A and 6B are views explaining a light-emitting device of the present invention.

FIGS. 7A to 7D are views each explaining an electronic device of the present invention.

FIG. 8 is a view explaining an electronic device of the present invention.

FIGS. 9A to 9C are views each explaining a lighting apparatus of the present invention.

FIG. 10 is a view explaining a lighting apparatus of the present invention.

FIG. 11 is a view explaining a lighting apparatus of the present invention.

FIG. 12 is a view explaining a light-emitting device of the present invention.

FIG. 13 is a view explaining a light-emitting device of the present invention.

FIG. 14 is a view explaining a light-emitting device of the present invention.

FIGS. 15A and 15B are views each explaining a light-emitting device of the present invention.

### DETAILED DESCRIPTION OF THE INVENTION

As a light-emitting material that can be used in the present invention, a chalcogenide compound (a compound including any of chalcogen elements of Group 16 of the periodic table, that is, oxygen (O), sulfur (S), selenium (Se), tellurium (Te), or polonium (Po)) or a composite material thereof can be used as a base material; and a transition metal, a rare-earth metal, a compound thereof, or a fluorescent substance to which a halogen compound is added can be used as a luminescent center. For example, as an example of a base material, zinc oxide, zinc sulfide, zinc selenide, magnesium sulfide, calcium sulfide, strontium sulfide, or the like can be given. In addition, a composite material of the chalcogenide compound may be used, such as SrGa₂S₄, ZnMgS₂, or ZnSi₂O₄. Further, instead of the chalcogenide compound, a compound including an element of Group 15 of the periodic table (that is, nitrogen (N), phosphorus (P), arsenic (As), antimony (Sb), or bismuth (Bi)) may be used as a base material. As an example of the compound made from the element of Group 15 of the periodic table, for example, silicon nitride, gallium nitride, aluminum nitride, or the like is given. In addition, a composite material of nitride and the chalcogenide compound may be used as a base material.

When such a base material described above is used for an inorganic electroluminescent material (hereinafter, also referred to as an inorganic EL material), generation of a defect can be reduced by baking in an atmosphere including the same element as that of the base material. For example, in a case where the base material is a chalcogenide compound, the atmosphere including the same element as that of the base material is a sulfur (S) atmosphere, an oxygen (O) atmosphere, or the like. Since the material that is made to be an atmosphere is disposed separately from the base material when baking, an activator or a sub-activator of a material including an impurity element to be a luminescent center or the like can also be mixed into the base material. In the present invention, as a material made to be an atmosphere, instead of a material substituted for the base material, a material having an element that compensate a defect generated in the base material is used.

In a case of synthesizing an inorganic EL material, a muffle furnace, a horizontal tubular furnace, a vertical tubular furnace, or the like can be used as an electric furnace for baking. When baking, an open-tube type container such as a crucible can be used for containing a material. Alternatively, instead that a material is contained in a container, the material may be directly provided in a quartz tube, or the material may be sealed in the quartz tube (also referred to be a sealed tube). When a material is sealed in the tube, sealing can be performed in a vacuum state or can be performed together with an inert gas such as nitrogen or argon.

In a case where a tube made from a quartz material is used as a core tube of a sealed tube or an open tube, baking is preferably performed at a temperature of about 1300° C. or less, which does not exceed an allowable temperature limit of a quartz glass. As baking is performed at a higher temperature, attached scaffolding such as an alkali metal is diffused, which cannot be swept away by washing of the quartz tube itself, and then, the allowable temperature limit of the quartz tube may be lowered or quartz may be crystallized to be cristobalito. Therefore, in addition to quartz, as the core tube, a ceramic tube can be used depending on the purpose, such as alumina (Al₂O₃), aluminum nitride (AlN), silicon carbide (SiC), boron nitride (BN or PBN), magnesia (MgO), zirconia (ZrO₂), calcia (CaO), silica (SiO₂), titania (TiO₂), or yttria (Y₂O₅). Alternatively, a tube such as a Tanmann tube can be used, one side of which is closed. However, in a case of using a sealed tube, it is difficult to use ceramic due to a problem of processing, and quartz is preferably used.

In a sealed tube or an open tube, a crucible may be used as a container for containing a material, or a crucible is not necessarily used depending on a purpose. In a case of using a crucible, alumina (Al₂O₃), aluminum nitride (AlN), silicon carbide (SiC), boron nitride (BN or PBN), platinum (Pt), titanium (Ti), graphite (C), magnesia (MgO), zirconia (ZrO₂), calcia (CaO), silica (SiO₂), titania (TiO₂), yttria (Y₂O₅), or the like, which are cleaned well, can be given as a material. The crucible may have a cover made from the same material as the crucible. In addition, a hole or a groove may be provided in the cover. In any cases of containing a material in the crucible and of putting a material directly in a tube such as a quartz tube, the material is preferably contained so that a surface area of the material becomes large in order to further expose the material to an atmosphere inside of the tube well. Therefore, a deep crucible may be used, but a shallow crucible is preferable.

In a case of using a tubular furnace, disposition of a base material and a material made to be an atmosphere is different in a vertical tubular furnace and a horizontal tubular furnace. In the horizontal tubular furnace, either of an open tube or a sealed tube can be used. In the vertical tubular furnace, a sealed tube is desirable for working properties. When a boiling point or a sublimation temperature of the material made to be an atmosphere is lower than that of the base material, the material made to be an atmosphere may be disposed at a position where a temperature is further lower utilizing a difference in distribution of temperature in the tubular furnace. On the other hand, when a boiling point or a sublimation temperature of the material made to be an atmosphere is higher than that of the base material, the material made to be an atmosphere may be disposed at a position where a temperature is further higher. Alternatively, the base material and the material made to be an atmosphere can be disposed, so that only the material made to be an atmosphere becomes gas but the base material does not become gas.

In a case where an atmosphere is made from the same element as an element included in the base material and baking is performed using an open tube with the use of a core tube, the material making an atmosphere (hereinafter, also described as an atmosphere material) is needed to have a boiling point or a sublimation temperature close to that of the base material. When the atmosphere material has a lower boiling point or a lower sublimation temperature than the base material, an atmosphere of the atmosphere material is made before the base material is reacted. On the other hand, the atmosphere material has a higher boiling point or a higher sublimation temperature than the base material, baking proceeds in a state where an atmosphere of the atmosphere material is not completely made, or baking is completed before the atmosphere is made. In a case of the sealed tube, when the atmosphere material has a lower boiling point or a lower sublimation temperature than the base material to some extent, there is no problem, particularly, and range of selection of a material spreads. Further, since sulfur or oxygen is supplied in the atmosphere even when a defect is caused by sulfur or oxygen being drawn from the base material, a material that has no defect or a small defect can be synthesized. However, when an atmosphere in the sealed tube is tried to be made from an atmosphere material having a higher boiling point or a higher sublimation temperature than a base material, the synthesis is completed before the atmosphere is made.

Therefore, as for a material making an atmosphere, although the boiling point or the sublimation temperature of the material is close to that of the base material, there is necessary to use a material having a lower boiling point or a lower sublimation temperature than a base material to some extent. For example, in a case of using zinc sulfide for a base material, the boiling point of zinc sulfide is about 900° C. and the sublimation temperature thereof is about 1100 to 1200° C. Therefore, in the case of making a sulfur atmosphere, there is necessary to use an atmosphere material having a lower boiling point or a lower sublimation temperature than the above-described zinc sulfide. The base material itself may be used as an atmosphere material. On the contrary, in a case of using a material having a much lower boiling portion, for example, an elemental sulfur (about 450° C.) or carbon disulfide (about 45° C.), there is a risk in that sulfur or the like is precipitated at a low temperature portion when using a tubular furnace with distribution of temperature. In particular, sulfide tends to avoid oxidation in baking, and an oxygen atmosphere is not preferable. In the case of using hydrogen sulfide which is toxic, there is difficulty in working and management because a problem occurs and attention is needed. Thus, as the atmosphere material thereof, sulfide of a transition metal or a rare-earth metal or a composite material thereof is considered, such as Al₂S₃, CaS, FeS, Na₂S, GaS, or Ga₂S₃. In addition, in a case of making a nitrogen atmosphere, a material such as Ca₃N₂, GaN, or Si₃N₄ can be used. Further, a material may be selected so that only an atmosphere material becomes gas and a base material does not become gas.

A light-emitting material of an inorganic EL material has high purity without including an impurity other than an impurity to be a luminescent center, which is important. Thus, flux is used as an atmosphere material to make a flux atmosphere, whereby an inorganic EL material with a favorable purity and a single phase can be obtained. The single phase indicates a state in which a sub-product is not mixed in an object material, in other words, a state having favorable crystallinity in which products having the same composition are gathered. Flux is used for enhancing crystallinity or for producing a single crystal. In the case where flux is used when baking, a halogen compound is in many cases used as flux. The halogen compound is formed from a halogen element (Group 17 of the periodic table) of a transition metal or a rare-earth metal, that is, fluorine (F), chloride (Cl), bromine (Br), iodine (I), or astatine (At). For, example, magnesium chloride, potassium chloride, lead chloride, sodium chloride, zinc chloride, barium chloride, ammonium chloride, sodium iodide, potassium iodide, barium bromide, copper(I) chlorine, copper(II) chlorine, or the like can be given.

Such flux serves as a carrier gas and can make the object material to be precipitated at a low temperature portion in a sealed tube. Further, a material can be synthesized in a different portion from a portion where the material is disposed when baking. Therefore, even in a case where flux includes an impurity that gives adverse effect to the light-emission mechanism, the material can be synthesized such that the impurity concentration in the synthesized material is lower than that of the flux. Since the flux is disposed at a portion that is separated from the base material so as not to be mixed, an atmosphere of the flux can be made without being included the impurity, which is included in the flux, in the base material. A single crystalline substance is located as a core for crystalline growth at a low temperature portion where the object material is precipitated, whereby crystalline growth can be promoted. The single crystal may be a single crystalline substrate or a single crystal itself with a size of about several hundred micron to several thousand micron. In addition to gallium arsenide or sapphire, the single crystal is nitride single crystal such as gallium nitride or aluminum nitride, carbide single crystal such as silicon carbide, oxide single crystal such as alumina, magnesia, or zinc oxide, or metal single crystal such as silicon. Such single crystal is selected in consideration of a crystal system of a material to be manufactured. A single crystal having the same crystal system as the material for crystalline growth is preferably used.

As one mode of a manufacturing method of an electroluminescent material in accordance with the present invention, a first material and a second material are provided in a sealed-tube container so as not to be contacted with each other. The first material is contained in a first crucible. The second material is contained in a second crucible, which is made to be an atmosphere when baking. Then, the first material and the second material are baked to form a third material in a different portion from those of the first material and the second material. It is to be noted that the second material includes an impurity giving adverse effect to the light-emission mechanism, and an impurity included in the third material has lower concentration than that of the second material. Further, the third material may be in a single crystalline state. Furthermore, a single crystalline material having function for promoting crystallization may be provided in a different portion from those of the first material and the second material.

In the above structure, the second material may be a compound including an element selected from Group 15, 16, or 17 of the periodic table. An atmosphere in the sealed reaction container before baking may be of a vacuum or of an inert gas. When vapor pressure of the first material is lower than that of the second material, the second material may be disposed at a lower temperature portion than that of the first material in a reaction container having distribution of temperature. On the other hand, when vapor pressure of the first material is higher than that of the second material, the second material may be disposed at a higher temperature portion than that of the first material.

In the above structure, the first material and the second material can be separately contained in the sealed reaction container. For example, the first material and the second material may be separated with an orifice, or the first material and the second material may be contained in the first crucible and the second crucible, respectively.

In the above structure, as the first material and the second material, inorganic substances can be used.

A light-emitting element using a material manufactured in the above structure and a light-emitting device such as a lighting apparatus that has the light-emitting element can be provided. Further, an electronic device using a light-emitting device of the present invention for a display portion can be provided.

In the present invention, a light-emitting material having further favorable efficiency, a light-emitting material having long life time, and a light-emitting material having high luminance are formed with use of various base materials and addition of various materials including an impurity element to be a luminescent center, and further, emission color can be changed. As the light-emitting material, a chalcogenide compound such as sulfide or oxide, nitride, or a composite material thereof is mainly used. An electroluminescent material of the present invention may be not only a light-emitting material that is to be a light-emitting layer in a light-emitting element, but also a material for forming any of layers and regions formed of a plurality of layers for functional separation in the light-emitting element.

A light-emitting device that has the above light-emitting element is included in the category of the present invention. A light emitting device of the present specification includes an image display device, a light-emitting device, and a light source (including a lighting apparatus) in the category of the present invention. In addition, a light-emitting device includes a module in which a connector such as an FPC (Flexible Printed Circuit), a TAB (Tape Automated Bonding) tape, or a TCP (Tape Carrier Package) is attached to a panel where a light-emitting element is formed, a module where an end of the TAB tape or the TCP is provided with a printed wiring board, or a module where an IC (Integrated Circuit) is directly mounted on a light-emitting element by a COG (Chip On Glass) method.

Hereinafter, embodiment modes will be explained in detail with reference to drawings. However, it is easily understood by those skilled in the art that various changes and modifications are possible, unless such changes and modifications depart from the content and the scope of the invention. Therefore, the present invention is not construed as being limited to the description of the following embodiment modes.

### Embodiment Mode 1

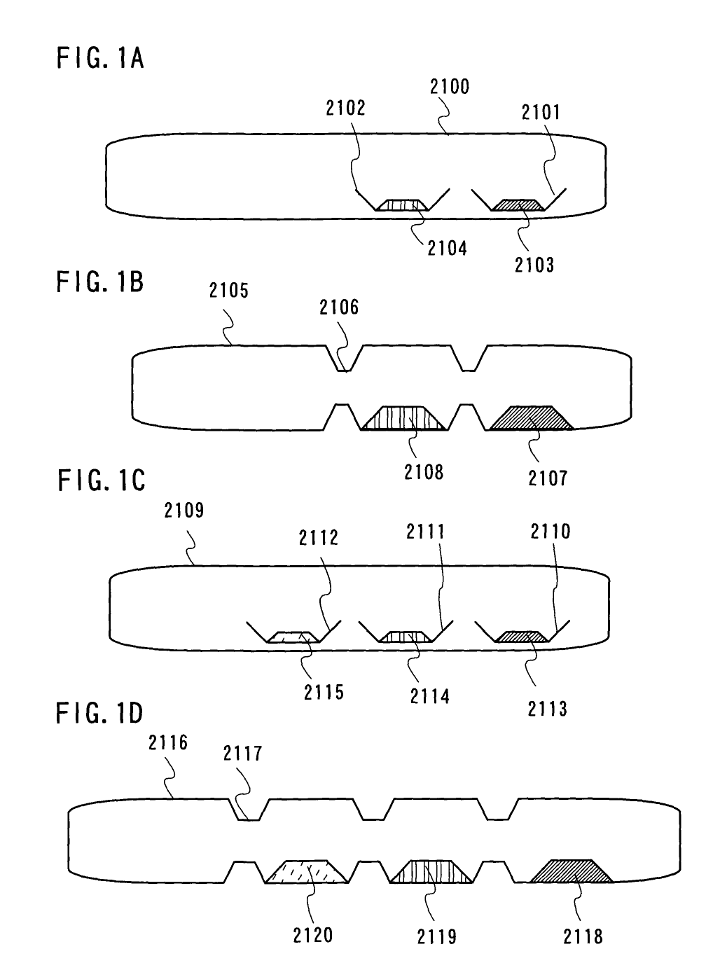

In this embodiment mode, a manufacturing method of an inorganic EL material according to the present invention will be explained with reference to FIGS. 1A to 1D.

A manufacturing method of an inorganic EL material shown in this embodiment mode is a baking method using a sealed tube. As shown in FIG. 1A, in a sealed tube 2100 made of quartz or the like, which is sealed in a certain atmosphere, a crucible 2101 of alumina or the like and a crucible 2102 are separately disposed. The crucible 2101 contains a base material 2103, and the crucible 2102 contains an atmosphere material 2104 used for making an atmosphere in baking. It is to be noted that the above-described materials may be used for the base material 2103 and the atmosphere material 2104, and an impurity element that is to be a luminescent center may be added to the base material as an activator. Each material of the crucible 2101 and the crucible 2102 may be changed depending on a material to be contained. Here, in the case where quartz is used as a material, the sealed tube means a quartz tube of which both ends are not opened but closed to be sealed hermetically using a burner or the like in the state where an inside of the tube is in a vacuum or where specific gas is put in the tube. In the sealed tube, two spaces, not one space, are formed, and the base material 2103 and the atmosphere material 2104 may be each disposed in a discrete space.

As shown in FIG. 1B, crucibles are not used, and a base material 2107 and an atmosphere material 2108 can be directly provided in a sealed tube 2105 made of quartz or the like. In such a case, an orifice 2106 is preferably provided between the base material 2107 and the atmosphere material 2108 so as not to mix the base material 2107 and the atmosphere material 2108 due to work such as containing of the material or baking. In such a case, baking is preferably performed at a temperature that does not exceed a crystalline temperature of the quartz itself or an allowable temperature limit, that is at about 1300° C. or less. It is to be noted that the orifice indicates a portion in the sealed tube 2105 of which a diameter is narrowed.

In addition, it is possible to dispose three or more materials each of which is contained in a discrete crucible in a sealed tube. For example, as shown in FIG. 1C, in a sealed tube 2109, a crucible 2110 containing a base material 2113, a crucible 2111 containing an atmosphere material 2114, and a crucible 2112 containing an atmosphere material 2115 can be disposed. Similarly, as shown in FIG. 1D, a plurality of orifices 2117 are provided in a sealed tube 2116, and a base material or an atmosphere material can be directly contained in the sealed tube without using a crucible. In FIG. 1D, reference numerals 2119 and 2120 are an atmosphere material corresponding to a base material 2118.

When the orifice is provided as shown in FIG. 1B and FIG. 1D, it is possible to prevent generation of an impurity and an unreacted material, which is to be unnecessary after baking, and by-product material by mixture or contact of the base material and the atmosphere material in the sealed tube. In addition, a baked product can be precipitated at a desired portion in the sealed tube, and yield of the obtained-baked product is improved.

In such a manner, as for the base material and the atmosphere material that are sealed in the sealed tube, a temperature in the sealed tube and a baking time are determined depending on a base material and an atmosphere material to be used so that the base material is baked after the atmosphere material is evaporated earlier than the base material and the inside of the sealed tube is made to have a specific atmosphere. Specifically, with the use of distribution of temperature of a tubular furnace, when vapor pressure of the base material is lower than that of the atmosphere material, the base material is preferably provided in a higher-temperature portion than the atmosphere material in the sealed tube. When vapor pressure of the base material is higher than that of the atmosphere material, the base material is preferably provided in a lower-temperature portion than the atmosphere temperature in the sealed tube. For example, in FIG. 1A, when vapor pressure of the base material 2103 is lower than that of the atmosphere material 2104, the crucible 2101 containing the base material 2103 is provided in a higher-temperature portion than the crucible 2102 containing the atmosphere material 2104 in the sealed tube 2100.

Although distribution of temperature of the tubular furnace is used in the case of sealing, a size or length of the sealed tube itself can be reduced in order to decrease a large difference of temperature in the sealed tube, depending on the case. Further, a muffle furnace with small distribution of temperature can be used in addition to the tubular furnace. Alternatively, it is also possible to dispose the sealed tube around bubble-form ceramics to be baked, in order to further uniform a temperature applied to the sealed tube.

When an inorganic EL material is manufactured by such a mode, unnecessary impurities can be reduced in the base material, and an inorganic EL material of which emission luminance, emission efficiency, and life time are improved can be obtained. Further, since unnecessary impurities are not included, a washing step can be omitted.

### Embodiment Mode 2

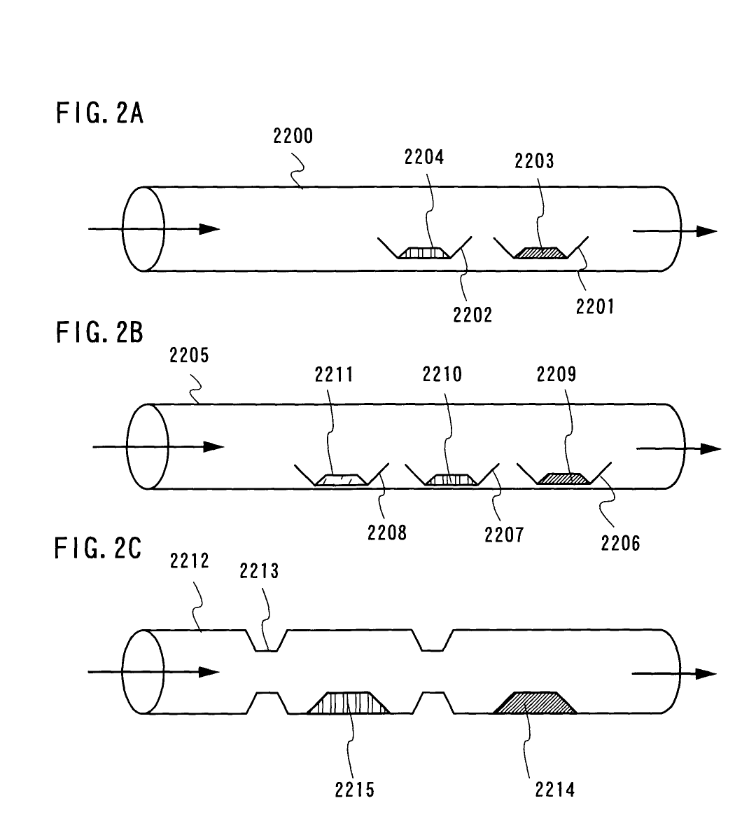

In this embodiment mode, a manufacturing method of an inorganic EL material according to the present invention will be explained with reference to FIGS. 2A to 2C.

A manufacturing method of an inorganic EL material shown in this embodiment mode is a baking method using an open tube. In a case where baking is performed in a horizontal tubular furnace as shown in FIG. 2A, a quartz tube is used as a core tube 2200, and a base material 2203 contained in a crucible 2201 and an atmosphere material 2204 contained in a crucible 2202 are provided in the core tube. At this point in time, the flow is produced in the open tube using an inert gas that is to be a carrier gas. Here, the atmosphere material 2204 is disposed in the upstream of flow of the carrier gas, whereby the base material 2203 can be exposed to an atmosphere of the atmosphere material 2204 in the core tube 2200 that is the open tube. As the base material and the atmosphere material, the above materials may be used, and an impurity element to be a luminescent center may be added to the base material as an activator.

As disposition of the base material 2203 and the atmosphere material 2204 in the core tube 2200, the atmosphere material 2204 is disposed in a position at an appropriate temperature in consideration of distribution of the tubular furnace, which is the upstream of the flow of the carrier gas with respect to the base material 2203 in the core tube 2200. For example, in a case where a boiling point or a sublimation temperature of the atmosphere material is lower than that of the base material, if a position at a highest temperature is in a center of the tubular furnace, the base material is provided in the center portion, and the atmosphere material is provided in the upward portion from the center portion. On the other hand, in a case where a boiling point or a sublimation temperature of the atmosphere material is higher than that of the base material, if a position at a highest temperature is in a center of the tubular furnace, the atmosphere material is provided in the center portion, and the bases material is provided in the downward portion from the center portion. At this time, in order to further expose the base material in the atmosphere, it is desirable to use a shallow and low-height crucible or container. Since gas is generated in an atmospheric air even in the open tube due to gas of the atmosphere material or degassing from the base material, a duct passes through the core tube 2200, and treatment may be performed by an exclusion device passing through the core tube if necessary.

Further, three or more materials each of which is contained in a discrete crucible can be disposed in a core tube. For example, as shown in FIG. 2B, a base material 2209 contained in a crucible 2206, an atmosphere material 2210 contained in a crucible 2207, and an atmosphere material 2211 contained in a crucible 2208 can be disposed in a core tube 2205. At this time, an inert gas or the like is used as a carrier gas in order to make flow of gas generated from the atmosphere materials 2210 and 2211, and the core tube 2205 is treated by a duct passing through the core tube 2205. Disposition of the base material 2209 and the atmosphere materials 2210 and 2211 in the core tube 2205 is the same as the disposition of FIG. 2A. When there are two types of atmosphere materials, an atmosphere material having a lower boiling point or a lower sublimation temperature is desirably disposed at a low-temperature portion.

Further, as shown in FIG. 2C, an atmosphere material and a base material may be directly provided in a core tube without using crucibles containing a material. In such a case, it is preferable that an orifice 2213 be provided for a core tube 2212 so as not to directly mix a base material 2214 and an atmosphere material 2215. Baking not using a crucible is effective in a case where baking is performed at around 1000° C. where quartz that is a material of the core tube does not cause a reaction.

The base material and the atmosphere material disposed in the core tube as the above are held and baked at an intended temperature for an intended time. In a case of an open tube, the core tube can be filled with fiber-form quartz glass so as not to release heat from end portions of the core tube. In a case of using a crucible, hollow alumina or hollow zirconia such as bubble alumina or bubble zirconia can be used so as to uniformly heat the entire crucible without distribution of temperature. Because of having hollow, holding heat is further improved, and the entire crucible can have uniform distribution of temperature.

When an inorganic EL material is manufactured using a manufacturing method shown in this embodiment mode, unnecessary impurities can be reduced in the base material, and an inorganic EL material of which emission luminance, emission efficiency, life time are improved can be obtained. Further, since unnecessary impurities are not included, a washing step can be omitted.

### Embodiment Mode 3

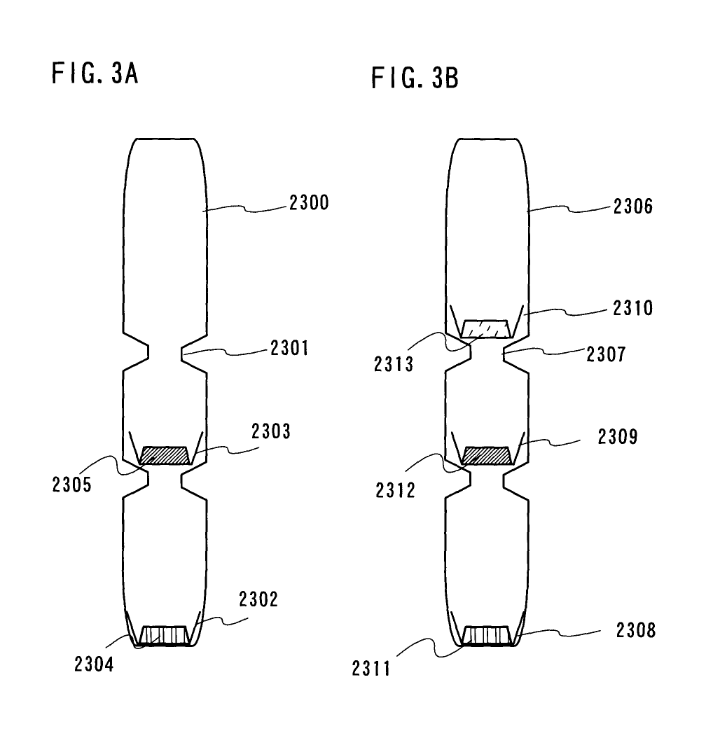

In this embodiment mode, a manufacturing method of an inorganic EL material according to the present invention will be explained with reference to FIGS. 3A and 3B.

A manufacturing method of an inorganic EL material shown in this embodiment mode is a baking method in a case of disposing samples vertically in an electric furnace. As shown in FIG. 3A, in a case of two materials, a sealed tube 2300 is provided with an orifice 2301, and a base material 2305 and an atmosphere material 2304 are provided therein. In the case of a vertical tubular furnace, a container such as a crucible cannot be fixed without a portion to be hung such as an orifice. First, a crucible 2302 is disposed at a bottom of a quartz tube one side of which is sealed, and an atmosphere material 2304 is contained. Next, the orifice 2301 is processed at a position separated from the crucible 2302. In the process, heating is performed with a burner or the like to make a hanging portion where a crucible 2303 can be put. Then, the crucible 2303 is disposed on the orifice 2301, and a base material 2305 is contained. Lastly, while the air of the quartz tube is drawn to make a vacuum, the other side of end portions of the quartz tube is sealed. Thus, the sealed tube 2300 can be manufactured. At this time, the air of the quartz tube is drawn to make the vacuum and an atmosphere in the sealed tube is kept in a vacuum; however, the inside of the sealed tube may be filled with an inert gas.

Further, as shown in FIG. 3B, three or more crucibles may be disposed in a sealed tube. A manufacturing method of a sealed tube 2306 and an orifice 2307 are the same as that in FIG. 3A. However, an atmosphere material 2311 contained in a crucible 2308 and an atmosphere material 2313 contained in a crucible 2310 are respectively disposed at a lower part and an upper part of the sealed tube in terms of a base material 2312 contained in a crucible 2309. At this time, disposition of each material can be changed in consideration of a boiling point or a sublimation temperature of each material and distribution of temperature of a vertical tubular furnace or a muffle furnace.

The base material and the atmosphere material disposed in the sealed tube as the above are held and baked at an intended temperature for an intended time. When the entire sealed tube is baked in an environment having no distribution of temperature, a muffle furnace may be used. When distribution of temperature is intentionally utilized, a vertical tubular furnace may be used.

When the inorganic EL material is manufactured by a manufacturing method shown in this embodiment mode, unnecessary impurities can be reduced in the base material, and an inorganic EL material of which emission luminance, emission efficiency, and life time are improved can be obtained. Further, since unnecessary impurities are not included, a washing step can be omitted.

### Embodiment Mode 4

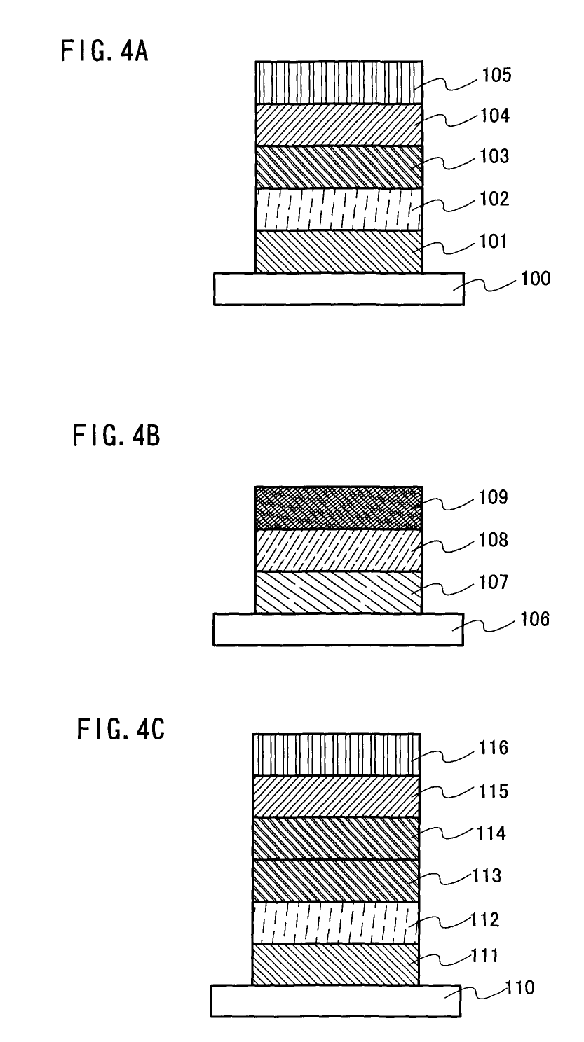

In this embodiment mode, a thin film light-emitting element which utilizes an inorganic EL material made according to a method for manufacturing an electroluminescent material according to the present invention for light-emitting layer will be explained with reference to FIG. 4A. A light-emitting element shown in this embodiment mode has an element structure in which a first electrode 101 and a second electrode 105 are provided over a substrate 100, with a first dielectric layer 102, a light-emitting layer 103, and a second dielectric layer 104 interposed between the first electrode 101 and the second electrode 105. Note that in this embodiment mode, the first electrode 101 and the second electrode 105 will be explained below with an assumption that each can function both as an anode and as a cathode.

The substrate 100 is used as a supporting base of the light-emitting element. For the substrate 100, glass, quartz, plastic or the like can be used. Note that any material other than these can be used as long as it functions as a supporting base in a manufacturing process of the light-emitting element.

For the first electrode 101 and the second electrode 105, a metal, an alloy, a conductive compound, a mixture thereof, or the like can be used. Specifically, examples thereof are indium tin oxide (ITO), indium tin oxide containing silicon or silicon oxide, indium zinc oxide (IZO), indium tin oxide containing tungsten oxide and zinc oxide (IWZO), and the like. These conductive metal oxide films are generally formed by sputtering. For example, indium zinc oxide (IZO) can be formed by sputtering using a target in which zinc oxide of 1 to 20 wt % is added to indium oxide. Indium oxide containing tungsten oxide and zinc oxide (IWZO) can be formed by sputtering using a target containing tungsten oxide of 0.5 to 5 wt % and zinc oxide of 0.1 to 1 wt % with respect to indium oxide. Alternatively, aluminum (Al), silver (Ag), gold (Au), platinum (Pt), nickel (Ni), tungsten (W), chromium (Cr), molybdenum (Mo), iron (Fe), cobalt (Co), copper (Cu), palladium (Pd), or a nitride of a metal material (e.g. titanium nitride (TiN)) etc. can be used. It is to be noted that in a case where the first electrode 101 or the second electrode 105 is formed to have a light-transmitting property, a film of a material with low visible light transmittance can also be used for a light-transmitting electrode when formed with a thickness of approximately 1 nm to 50 nm, preferably, 5 nm to 20 nm. It is to be noted that the electrode can also be formed by vacuum evaporation, CVD, or a sol-gel method other than sputtering.

However, since light emission is extracted to the outside by passing through the first electrode 101 or the second electrode 105, it is necessary that at least one of them be formed of a light-transmitting material. Also, it is preferable that a material be selected so that a work function of the first electrode 101 may be higher than that of the second electrode 105. Further, it is not necessary that the first electrode 101 and the second electrode 105 each have a single-layer structure, and a structure with two or more layers can be employed.

There is no problem as long as known materials are used for the first dielectric layer 102 and the second dielectric layer 104, but it is particularly favorable to use a material with a high dielectric constant. For these dielectric layers, an organic material or an inorganic material can be used. If an organic material is used, for example, an acetal resin, an epoxy resin, methyl methacrylate, polyester, polyethylene, polystyrene, and cyano ethyl cellulose can be used. If an inorganic material is used, a nitride such as an aluminum nitride (AlN) or a boron nitride (BN), or an oxide such as a barium titanate (BaTiO₃), strontium titanate (SrTiO₃), lithium titanate (LiTiO₃), lead titanate (PbTiO₃), tantalum pentoxide (Ta₂O₅), bismuth oxide (Bi₂O₃), calcium titanate (CaTiO₃), potassium niobate (KNbO₃), silicon oxide (SiO₂), or aluminum oxide (Al₂O₃) can be used. Also, the material can be a composite of these inorganic materials. Further, it is not necessary that the first dielectric layer 102 and the second dielectric layer 104 each have a single layer, and two or more layers can be provided. Furthermore, it is favorable that film thickness of the first dielectric layer 102 and the second dielectric layer 104 each be 10 nm to 1000 nm, preferably about 300 nm to 800 nm.

The light-emitting layer 103 may be formed using a material manufactured according to the method of the present invention can be used. In particular, a chalcogenide compound is used for a base material: e.g. an oxide, a sulfide, or a selenide including a metal element belonging to Group 2 to Group 13 of the periodic table. For example, zinc sulfide, copper sulfide, aluminum sulfide, calcium sulfide, strontium sulfide, selenium sulfide, magnesium sulfide can be given as the sulfide. As the oxide, zinc oxide, yttrium oxide, gallium oxide etc. can be given. As the selenide, zinc selenide, cadmium selenide, barium selenide etc. can be given. Furthermore, a composite material in which two or more kinds of these chalcogenide compounds are mixed can also be used. For example, SrGa₂S₄, ZnMgS, Y₂O₂S, Zn₂SiO₄ and the like can be given. It is favorable that film thickness of the light-emitting layer be 10 nm to 1000 nm, preferably 30 nm to 500 nm.

In the light-emitting layer 103, a material containing an impurity element to be a luminescent center (described as a luminescent center material, hereafter) is added in addition to the chalcogenide compound to be the base material. A halogen compound can be given as an additive material. The halogen compound is a compound composed of a halogen element in Group 17 of the periodic table, that is, fluorine (F), chlorine (Cl), bromine (Br), iodine (I), or astatine (At). A compound composed of a halogen element is, for example, a compound containing the above halogen element, and at least one of the following: copper (Cu), silver (Ag), and gold (Au) in Group 11 which are transition metals; or cerium (Ce), samarium (Sm), europium (Eu), terbium (Th), and thulium (Tm), which are rare earth elements etc. in the periodic table. Examples of copper compounds are copper fluoride (CuF), copper chloride (CuCl), copper bromide (CuBr), copper iodide (CuI), copper sulfate (CuSO₄), copper acetate ((CH₃COO)₂Cu), copper nitrate (Cu(NO₃)₂) or the like. Also, a halogen compound including a typical metal element such as aluminum (Al) or gallium (Ga) can be used. Further, a composite material of halogen compounds including typical metal, transition metal or rare earth element can also be used. The luminescent center material, which is a halogen compound, has a mechanism of light emission where fluorine (F), chlorine (Cl), bromine (Br), or iodine (I) functions as a donor, and the transition metal or the rare earth element included in the halogen compound functions as an acceptor, and light is emitted by recombination of the donor and the acceptor. A plurality of halogen compounds described above can be added as additive materials of the light-emitting layer to the base materials of the light-emitting layer.

As is described in the above embodiment mode, with regard to the light-emitting layer of the light-emitting element explained in this embodiment mode, the materials made according to the following method are used: the base material mixed with the luminescent center material and the atmosphere material to be an atmosphere when baking each are baked in discrete crucibles.

The light-emitting element according to the present invention is not limited to the foregoing structure, and the dielectric layer formed in contact with the electrode can be formed either in contact with the first electrode or with the second electrode. Also, as shown in FIG. 4B, the light-emitting element can be organized so that only a light-emitting layer 108 is provided between a first electrode 107 and a second electrode 109 over a substrate 106, with no dielectric layer. Furthermore, the light-emitting element can be organized so that a p-type semiconductor layer and an n-type semiconductor layer are stacked between the first electrode and the second electrode, and either or both of the semiconductor layers function as light-emitting layer, with no dielectric layer.

In a case of adding a luminescent center material to a base material, solid-state reaction is used in an electroluminescent material according to the present invention. When a luminescent center material is added to a sulfide which serves as a base material, for example, the sulfide is made to contain the luminescent center material by the following method: the sulfide and the luminescent center material are weighed, mixed in a mortar so that grain diameters may be sufficiently small, uniform, and dispersed, and then reacted in an electric furnace by heating. It is preferable that a baking temperature be 500° C. to 2000° C. This is because solid-state reaction does not proceed when the temperature is less than 500° C., whereas the sulfide is decomposed when the temperature is higher than 2000° C. Although baking in a powder form can be carried out, it is preferable that the baking be carried out in a pellet form. The following method can also be taken: pre-baking is carried out first at a high temperature, and then baking at a lower temperature after adding a luminescent center material is carried out. Alternatively, the following method can also be taken: the base material is baked during the first baking, and during the second baking, the luminescent center material is added to the base material and baked. Further, in a case of carrying out the solid-state reaction, the reaction can be carried out under atmospheric pressure, in a rare gas (e.g. argon (Ar)) atmosphere, a nitrogen (N₂) atmosphere, an oxygen (O₂) atmosphere, or a hydrogen sulfide (H₂S) atmosphere. Furthermore, there is a case where it is preferable to carry out baking in a vacuum state, and the material can be baked in a tube, for example, of quartz in a vacuum state. Still further, the material is contained in a quartz tube in a vacuum state, and the baking can be carried out according to a chemical transport method utilizing distribution of temperature of an electric furnace for baking. It is to be noted that in the present embodiment mode, baking of the base material or baking of the base material to which the luminescent center material is added is performed according to the method shown in the above Embodiment Modes 1 to 3.

As a method for forming the first electrode, the second electrode, the first dielectric layer, and the second dielectric layer, the following methods can be used: a vacuum evaporation method such as a resistance heating evaporation method, an electron beam evaporation (EB evaporation) method, or a hot wall method; a physical vapor deposition (PVD) method such as a sputtering method, an ion plating method, or an MEB method; a chemical vapor deposition (CVD) method such as a metal organic CVD method or a low-pressure hydride transport CVD method; an atomic layer epitaxy (ALE) method, and the like. Further, as a wet method, an inkjet method, a spin coating method, a printing method, a spraying method, a squeegee method, an anodic oxidation method, a sol-gel method or the like can be used.

As a method of forming the light-emitting layer, the following methods can be used: a vacuum evaporation method such as a resistance heating evaporation method, an electron beam evaporation (EB evaporation) method, or a hot wall method; a physical vapor deposition (PVD) method such as a sputtering method, an ion plating method, or an MEB method; a chemical vapor deposition (CVD) method such as a metal organic CVD method or a low-pressure hydride transport CVD method; an atomic layer epitaxy (ALE) method, etc. Further, as a wet method, an inkjet method, a spin coating method, a printing method, a spraying method, a squeegee method, an anodic oxidation method, a sol-gel method or the like can be used.

A light-emitting element having a different structure is described with reference to FIG. 4C.

The light-emitting element has an element structure in which a first electrode 111 and a second electrode 116 are provided over a substrate 110, with a first dielectric layer 112, a first light-emitting layer 113, a second light-emitting layer 114, and a second dielectric layer 115 interposed between the first electrode 111 and the second electrode 116. Note that in this embodiment mode, the first electrode 111 and the second electrode 116 will be explained below with an assumption that either may function as an anode or a cathode.

Note that the above materials and formation methods can be used to form the substrate 110, the first electrode 111, the second electrode 116, the first dielectric layer 112, and the second dielectric layer 115. Also, as is shown in the above embodiment modes, the material manufactured with the following method is used for the first light-emitting layer 113 and the second light-emitting layer 114: the base material blended with a luminescent center material, and an atmosphere material to be an atmosphere when baking each are contained and baked in discrete crucibles. Further, the above materials can be used for the base material and the luminescent center material.

In a case of forming a light-emitting element having the two light-emitting layers, i.e. the first light-emitting layer and the second light-emitting layer, by having the same color of light emission, a light-emitting element with improved light emission intensity can be formed. And also, in a case of light emission of different colors, a light-emitting element having white color light emission can be formed if wider light-emitting spectrum is secured in a light-emitting element having mixed colors. It is not necessary that the number of light-emitting layers be limited to two, and if necessary, a light-emitting element having two or more light-emitting layers can be formed.

As a structure of the light-emitting layer, for example, zinc sulfide is used for the base material in the first light-emitting layer 113, and silver ion (Ag⁺¹) is used as the luminescent center material. In the second light-emitting layer 114 formed over the first light-emitting layer 113, zinc sulfide is used for the base material, and copper(I) ion (Cu⁺¹) and chlorine ion (Cl⁻¹) are used as the luminescent center material. Consequently, light of mixed colors can be emitted from one light-emitting element. In this manner, by forming the light-emitting element using the same base material in a plurality of light-emitting layers, deterioration due to a difference of the base materials can be prevented, and life time can be lengthened. However, it is not necessarily required that the base material of the first light-emitting layer and that of the second light-emitting layer be the same.

Also, in order to improve light emission intensity, calcium sulfide and europium(II) ion (Eu²⁺) are used as the base material and as the luminescent center material, respectively, in the first light-emitting layer 113; and yttrium oxide and europium(III) ion (Eu³⁺) are used as the base material and the luminescent center material, respectively, in the second light-emitting layer 114. In this manner, a light-emitting element with improved intensity even with single color light emission can be formed.

The light-emitting element in this embodiment mode can be improved in emission luminance, emission efficiency and life time since it has a light-emitting layer with an electroluminescence material made according to the manufacturing method of the present invention. Furthermore, a washing step can be omitted, and throughput in producing light-emitting elements improves, since unnecessary impurities are not included in the process of manufacturing electroluminescence material.

### Embodiment Mode 5

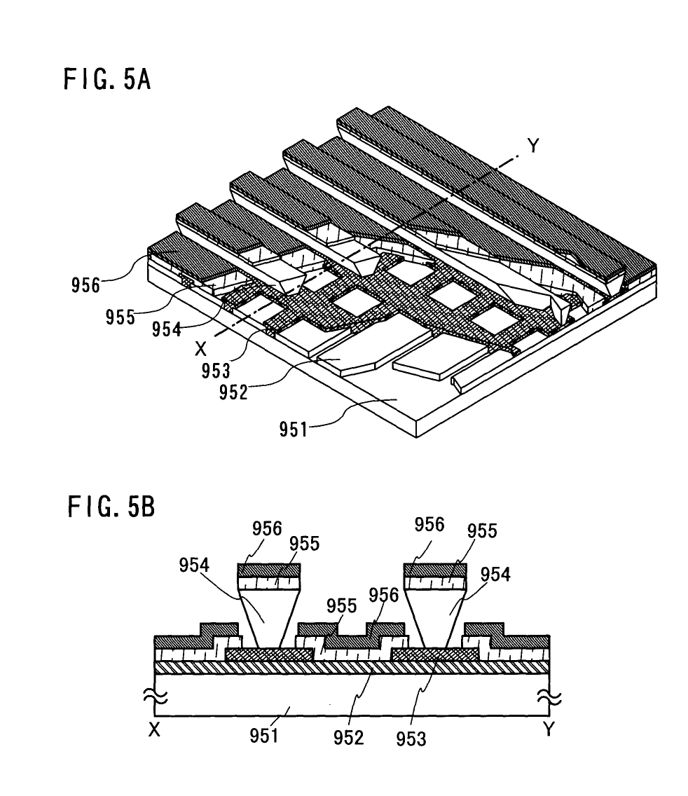

In this embodiment mode, a light-emitting device including the light-emitting element of the present invention will be explained with reference to FIGS. 5A and 5B

A light-emitting device shown in this embodiment mode is a passive light-emitting device in which a light-emitting element is driven without particularly providing an element for driving such as a transistor. FIG. 5A is a perspective view of a passive light-emitting device manufactured by applying the present invention, and FIG. 5B shows a part of the cross section taken along the line X-Y in FIG. 5A.

In FIGS. 5A and 5B, a first electrode 952 and a second electrode 956 are formed over a substrate 951, and a light-emitting layer 955 is provided between the first electrode 952 and the second electrode 956. Note that the light-emitting layer 955 is formed using an inorganic EL material formed according to a method of the present invention.

An end portion of the first electrode 952 is covered with an insulating layer 953. A partition layer 954 is provided over the insulating layer 953. Sidewalls of the partition layer 954 are slanted so that a distance between one of the sidewalls and the other becomes narrower toward a substrate surface. In other words, as shown in FIG. 5B, a cross-sectional surface in a short side direction of the partition layer 954 is trapezoidal, in which a base (a side that is in the same direction as the plane direction and is in contact with the insulating layer 953) is shorter than a top (a side that is in the same direction as the plane direction and is not in contact with the insulating layer 953). In this manner, the partition layer 954 is provided, whereby defects of the light-emitting element due to static electricity or the like can be prevented. Further, in the passive light-emitting device also, a light-emitting device of which emission luminance, emission efficiency and life time are improved by including the light-emitting element of the present invention, can be obtained. In addition, since the partition layer 954 having the shape as shown in FIGS. 5A and 5B is provided, a light-emitting layer 955 and a second electrode 956 can be formed in a self-alignment manner.

Although one structure of a light-emitting element is shown in this embodiment mode, it is not necessary to be bound to this structure. A dielectric layer may be formed over an electrode, and the light-emitting layer may have a stacked structure of a p-type semiconductor layer and an n-type semiconductor layer as shown in Embodiment Mode 4. Further, like a function separation type light-emitting element of an organic EL element, a lower layer in contact with a light-emitting layer can be provided, in addition to the light-emitting layer. This lower layer has a function of increasing orientation of a light-emitting layer and can serve as an injection layer or a transport layer.

The light-emitting device shown in this embodiment mode can improve its emission luminance, emission efficiency, life time, since the light-emitting device uses an inorganic EL material with reduced unnecessary impurities in a base material. In the manufacturing process of an inorganic EL, since unnecessary impurities are not contained, a washing step can be omitted, and throughput of the light-emitting device formed using the inorganic EL material can be enhanced.

### Embodiment Mode 6

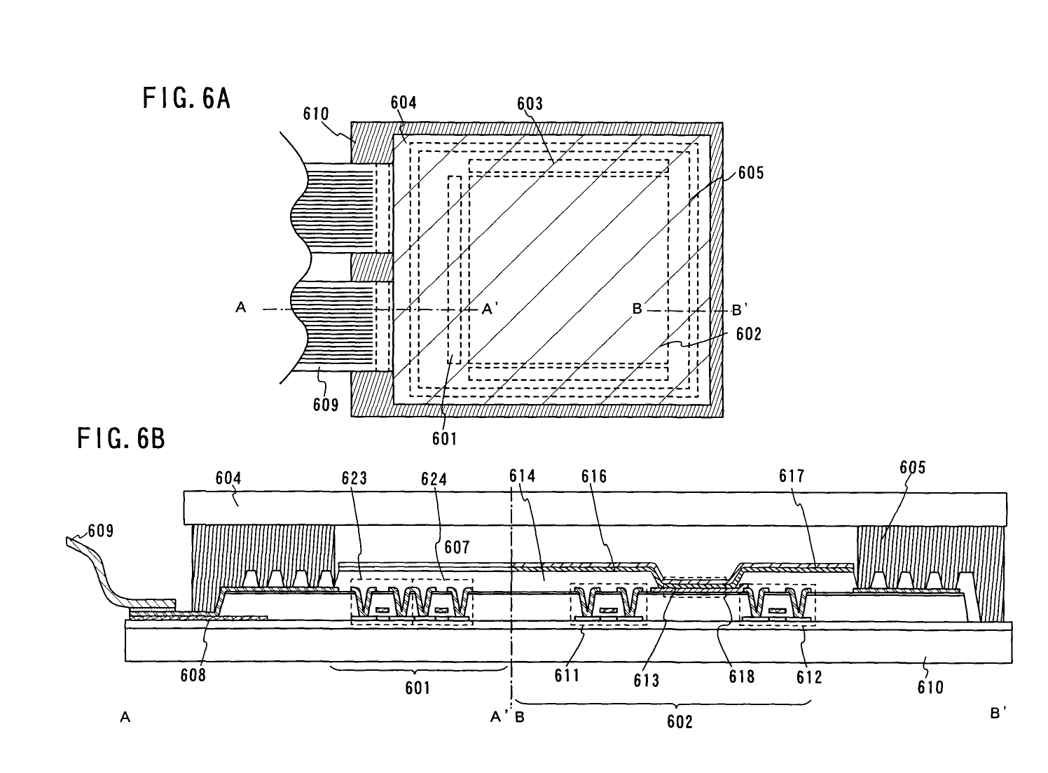

In this embodiment mode, a light-emitting device including the light-emitting element of the present invention will be explained with reference to FIGS. 6A and 6B.

In this embodiment mode, an active light-emitting device in which driving of a light-emitting element is controlled by a transistor will be explained. In this embodiment mode, a light-emitting device including the light-emitting element of the present invention in a pixel portion will be explained with reference to FIGS. 6A and 6B. FIG. 6A is a top view showing the light-emitting device and FIG. 6B is a cross-sectional view of FIG. 6A taken along lines A-A′ and B-B′. A reference numeral 601 denotes a driver circuit portion (a source side driver circuit); 602 denotes a pixel portion; and 603 denotes a driver circuit portion (a gate side driver circuit), each of which is indicated by a dotted line. A reference numeral 604 denotes a sealing substrate; 605 denotes a sealant; and a portion surrounded by the sealant 605 is a space 607.

It is to be noted that a lead wiring 608 shown in FIG. 6B is a wiring for transmitting signals to be input to the source side driver circuit 601 and the gate side driver circuit 603 and receives a video signal, a clock signal, a start signal, a reset signal, and the like from an FPC (Flexible Printed Circuit) 609 that is an external input terminal. Although only the FPC is shown here, the FPC may be provided with a printed wiring board (PWB). The light-emitting device in the present specification includes not only a case of providing just the light-emitting device, but also a case in which the light-emitting device is attached with an FPC or a PWB.

Next, a cross-sectional structure will be explained with reference to FIG. 6B. The driver circuit portions and the pixel portion are formed over an element substrate 610. In FIG. 6B, the source side driver circuit 601 that is one of the driver circuit portions and one pixel in the pixel portion 602 are shown.

A CMOS circuit that is a combination of an n-channel TFT 623 and a p-channel TFT 624 is formed as the source side driver circuit 601. A TFT forming the driver circuit may be that of a known CMOS circuit, PMOS circuit, or NMOS circuit. A driver integration type in which a driver circuit is formed over a substrate is described in this embodiment mode, but it is not always necessary and a driver circuit can be formed not over a substrate but outside of a substrate. The structure of the TFT is not particularly limited, and a staggered TFT may be employed, or an inversely staggered TFT may be employed. Crystallinity of a semiconductor film used for the TFT is not particularly limited either, and an amorphous semiconductor film may be used, or a crystalline semiconductor film may be used. Furthermore, a semiconductor material is not particularly limited, and an inorganic compound may be used, or an organic compound may be used.

The pixel portion 602 includes a plurality of pixels, each of which includes a switching TFT 611, a current control TFT 612, and a first electrode 613 which is electrically connected to a drain of the current control TFT 612. It is to be noted that an insulator 614 is formed to cover an end portion of the first electrode 613. Here, a positive type photosensitive acrylic resin film is used to form an insulator 614.

The insulator 614 is formed to have a curved surface with curvature at an upper end portion or a lower end portion thereof in order to obtain favorable coverage. For example, in the case of using positive type photosensitive acrylic as a material of the insulator 614, the insulator 614 is preferably formed to have a curved surface with a curvature radius (0.2 μm to 3 μm) only at an upper end portion. Either a negative type which becomes insoluble in an etchant by light irradiation or a positive type which becomes soluble in an etchant by light irradiation can be used as the insulator 614.

Over the first electrode 613, a light-emitting layer 616 and a second electrode 617 are provided. The light-emitting layer 616 is formed including an inorganic EL material formed by a manufacturing method of the present invention. At least one of the first electrode 613 and the second electrode 617 has a light-transmitting property, and light emission from the light-emitting layer 616 can be extracted to the outside. Note that if both the first electrode 613 and the second electrode 617 are formed of materials with light-transmitting properties, light emission can be extracted from both an element substrate 610 side and a sealing substrate 604 side, and a light-emitting element 618 can be used for a dual-emission device.

The first electrode 613, the light-emitting layer 616, and the second electrode 617 can be formed by various methods. Specifically, the electrodes and the light-emitting layer can be formed by a vacuum evaporation method such as a resistance heating evaporation method, an electron beam (EB) evaporation method, or a hot wall method; a physical vapor deposition (PVD) method such as a sputtering method, an ion plating method, or an MEB method; a chemical vapor deposition (CVD) method such as a metal organic CVD method or a low pressure hydride transport CVD method; an atomic layer epitaxy (ALE) method; or the like. Furthermore, an inkjet method, a spin coating method, a printing method, a spraying method, a squeegee method, an anodic oxidation method, a sol-gel method, or the like can be used. In addition, each electrode or each layer may be formed by using a different film formation method.

By attaching the sealing substrate 604 to the element substrate 610 with the sealant 605, a light-emitting element 618 is provided in the space 607 surrounded by the element substrate 610, the sealing substrate 604, and the sealant 605. The space 607 is filled with a filler, but there is also a case where the space 607 is filled with the sealant 605 or filled with an inert gas (nitrogen, argon, or the like).

An epoxy-based resin is preferably used for the sealant 605. It is preferable that such a sealant or a filler is formed using a material which does not allow penetration of moisture or oxygen as much as possible. As the sealing substrate 604, a plastic substrate formed of FRP (Fiberglass-Reinforced Plastics), PVF (polyvinyl fluoride), a polyester film; polyester or acrylic; or the like can be used instead of a glass substrate or a quartz substrate.

In the above manner, the light-emitting device including the light-emitting element of the present invention can be obtained.

The light-emitting device of the present invention includes the light-emitting element shown in Embodiment Mode 4.

The light-emitting device shown in this embodiment mode can improve its emission luminance, emission efficiency, life time, since the light-emitting device uses an inorganic EL material with reduced unnecessary impurity in a base material. In the manufacturing process of an inorganic EL, since unnecessary impurities are not contained, a washing step can be omitted, and throughput of the light-emitting device formed using the inorganic EL material can be enhanced.

### Embodiment Mode 7

In this embodiment mode, electronic devices according to the present invention which include in its part the light-emitting devices described in Embodiment Mode 6 will be explained. The electronic devices according to the present invention include light-emitting elements using an inorganic EL material formed by a manufacturing method of the present invention. Unnecessary impurities can be reduced in the base material of the inorganic EL material constituting the light-emitting element and an inorganic EL material with increased emission luminance, emission efficiency and life time can be obtained. Further, since unnecessary impurities are not contained beforehand, a step such as a washing step can be eliminated.

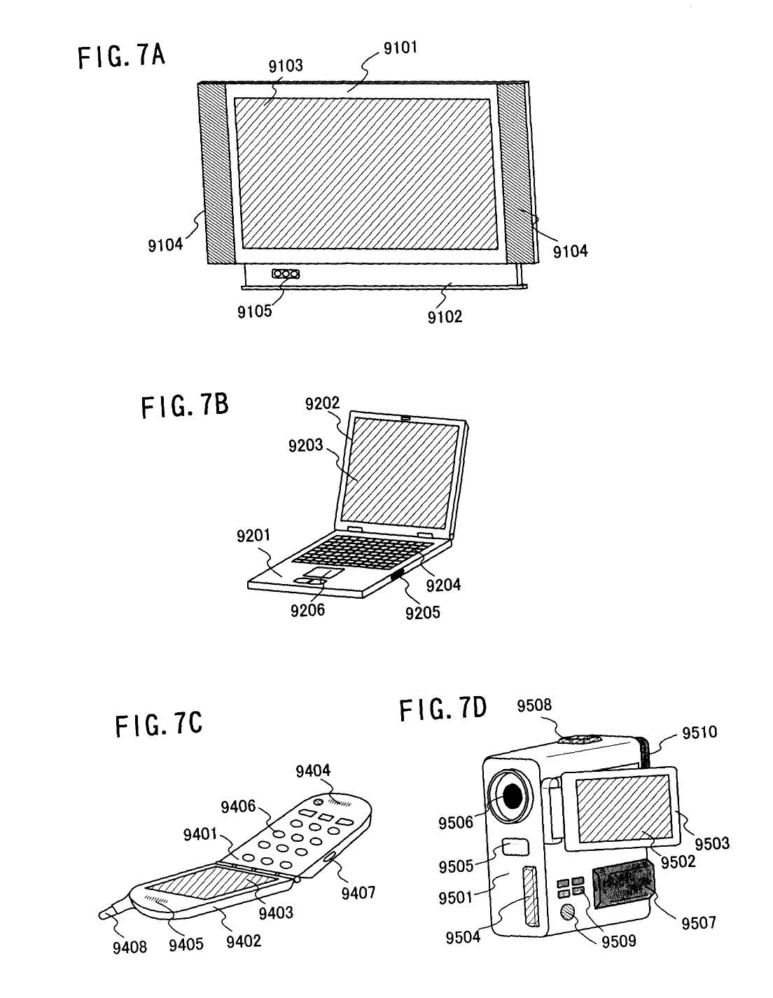

Examples of the electronic devices manufactured using the light-emitting device of the present invention are as follows: television appliances (simply referred to as televisions, or television receivers), cameras such as video cameras or digital cameras, goggle type displays, navigation systems, sound reproducing devices (car audio systems, audio components, and the like), computers, game machines, portable information terminals (mobile computers, cellular phones, mobile game machines, electronic books, and the like), image reproducing devices having recording media (specifically, devices for reproducing content of a recording medium such as a digital versatile disc (DVD) and having a display device for displaying the image), and the like. Specific examples of these electronic devices are shown in FIGS. 7A to 7D.

FIG. 7A shows a television device according to the present invention, which includes a chassis 9101, a supporting base 9102, a display portion 9103, a speaker portion 9104, a video input terminal 9105, and the like. In this television device, the display portion 9103 includes light-emitting elements using an inorganic EL material formed by a manufacturing method of the present invention, which are arranged in matrix. Consequently, in a case of a mixed color or white color light-emitting element, it is necessary to form a color filter such as for a liquid crystal.

FIG. 7B shows a computer according to the present invention, which includes a main body 9201, a chassis 9202, a display portion 9203, a keyboard 9204, an external connection port 9205, a pointing device 9206, and the like. In this computer, the display portion 9203 includes light-emitting elements using an inorganic EL material formed by a manufacturing method of the present invention, which are arranged in matrix.

FIG. 7C shows a cellular phone according to the present invention, which includes a main body 9401, a chassis 9402, a display portion 9403, an audio input portion 9404, an audio output portion 9405, operation keys 9406, an external connection port 9407, an antenna 9408, and the like. In this cellular phone, the display portion 9403 includes light-emitting elements using an inorganic EL material formed by a manufacturing method of the present invention, which are arranged in matrix.

FIG. 7D shows a camera according to the present invention, which includes a main body 9501, a display portion 9502, a chassis 9503, an external connection port 9504, a remote control receiving portion 9505, an image receiving portion 9506, a battery 9507, an audio input portion 9508, operation keys 9509, an eye piece portion 9510, and the like. In this camera, the display portion 9502 includes light-emitting elements using an inorganic EL material formed by a manufacturing method of the present invention, which are arranged in matrix.

In the above manner, an application range of the light-emitting device of the present invention is extremely wide, and this light-emitting device can be applied to electronic devices of a variety of fields.

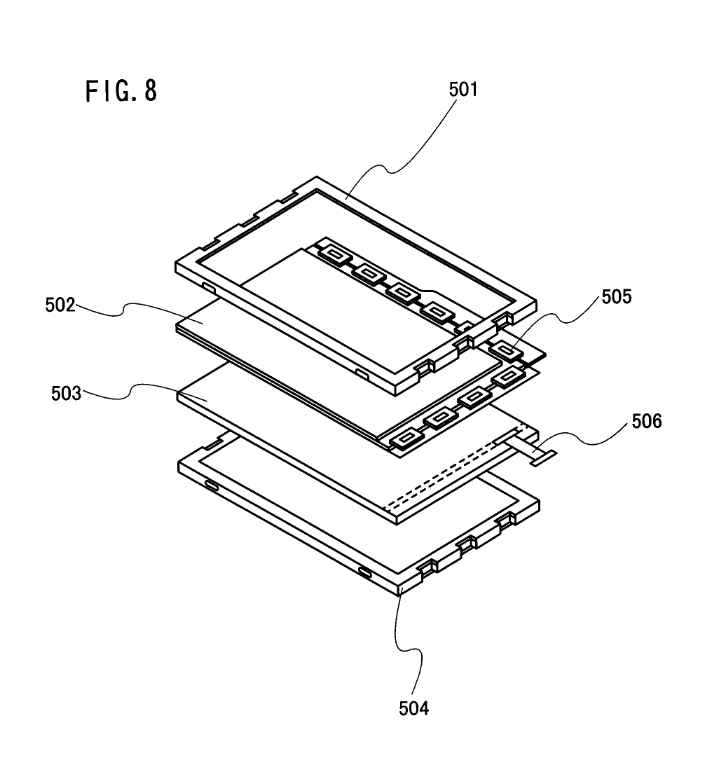

Further, the light-emitting device of the present invention can also be used for a lighting apparatus. One mode in which a light-emitting element of the present invention is used in a lighting apparatus is explained with reference to FIG. 8.

FIG. 8 shows an example of a liquid crystal display device using the light-emitting device of the present invention as a backlight. The liquid crystal display device shown in FIG. 8 includes a chassis 501, a liquid crystal layer 502, a backlight 503, and a chassis 504. The liquid crystal layer 502 is connected to a driver IC 505. The light-emitting device of the present invention is used as the backlight 503, to which current is supplied through a terminal 506.

By using the light-emitting device of the present invention as a backlight of a liquid crystal display device, a backlight with long life time, which is unique to an inorganic EL can be obtained. Since the light-emitting device of the present invention is a plane-emission device and can be formed to have a large area, a larger-area backlight can be obtained and a larger-area liquid crystal display device can also be obtained. Furthermore, since the light-emitting device is thin, reduction in thickness of the display device is also possible.

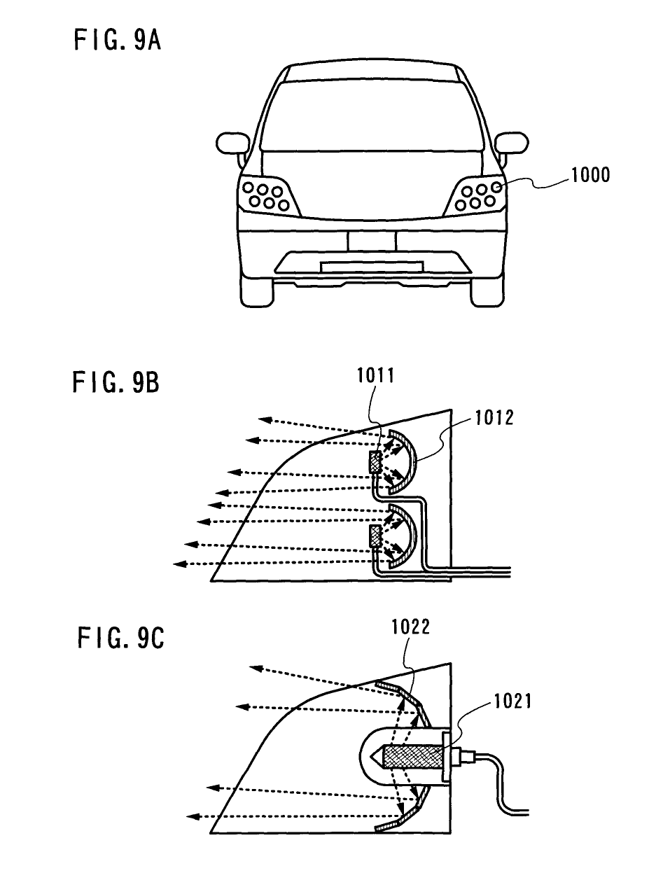

Furthermore, a light-emitting device to which the present invention can be used as a headlight of a car, bicycle, ship, or the like. FIGS. 9A to 9C show an example in which the light-emitting device to which the present invention is applied is used as a headlight of a car. FIG. 9B is an enlarged cross-sectional view showing a headlight 1000 of FIG. 9A. In FIG. 9B, the light-emitting device of the present invention is used as a light source 1011. Light emitted from the light source 1011 reflects off a reflector 1012 and is extracted to the outside. As shown in FIG. 9B, light with higher luminance can be obtained by using a plurality of light sources. FIG. 9C is an example in which a light-emitting device of the present invention that is manufactured in a cylindrical shape is used as a light source. Light emission from the light source 1021 reflects off a reflector 1022 and is extracted to the outside.

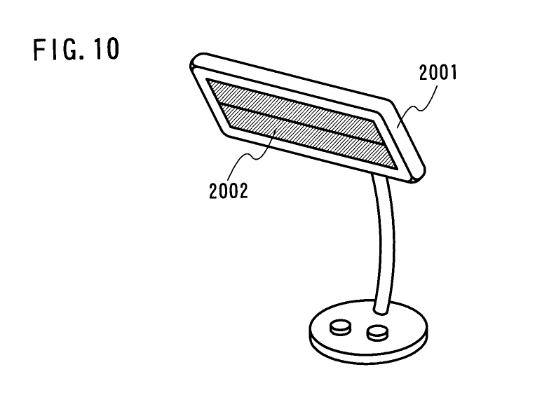

FIG. 10 shows an example in which the light-emitting device to which the present invention is applied is used as a desk lamp which is a lighting apparatus. The desk lamp shown in FIG. 10 includes a chassis 2001 and a light source 2002, and the light-emitting device of the present invention is used for the light source 2002. Since the light-emitting device of the present invention is capable of light emission with high luminance, this desk lamp can illuminate hands when fine handwork is required or the like.

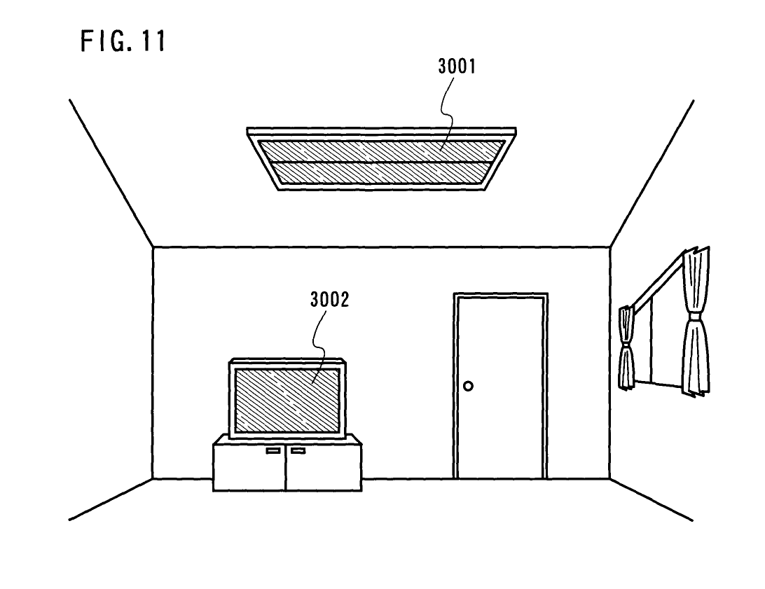

FIG. 11 shows an example in which the light-emitting device to which the present invention is applied is used for an indoor lighting apparatus 3001. Since the light-emitting device of the present invention can have a large area, it can be used for a large-area lighting apparatus. In addition, since the light-emitting device of the present invention is thin and low power consumption, the light-emitting device can be used for a thin lighting apparatus with low power consumption. In this manner, a television device 3002 according to the present invention like the one described in FIG. 7A can be set up in a room using as the indoor lighting apparatus 3001 the light-emitting device to which the present invention is applied, to view public broadcasts and movies. In such a case, since power consumptions of both devices are low, strong visuals can be viewed in a well-lit room without worrying about electricity cost.

The lighting apparatus are not limited to those exemplified in FIGS. 9A to 9C, 10 and 11, and the light-emitting device of the present invention can be applied to lighting apparatuses in various modes, including lighting apparatuses for houses and public facilities. In such a case, a light emission medium of the lighting apparatus of the present invention is a thin film, which increases design freedom. Accordingly, various elaborately-designed products can be provided to the marketplace.

The light-emitting device shown in this embodiment mode can improve its emission luminance, emission efficiency, life time, since the light-emitting device uses an inorganic EL material with reduced unnecessary impurity in a base material. In the manufacturing process of an inorganic EL, since unnecessary impurities are not contained, a washing step can be omitted, and throughput of the light-emitting device formed using the inorganic EL material can be enhanced.

### Embodiment Mode 8

In this embodiment mode, a light-emitting device having a light-emitting element manufactured by applying the present invention will be described.

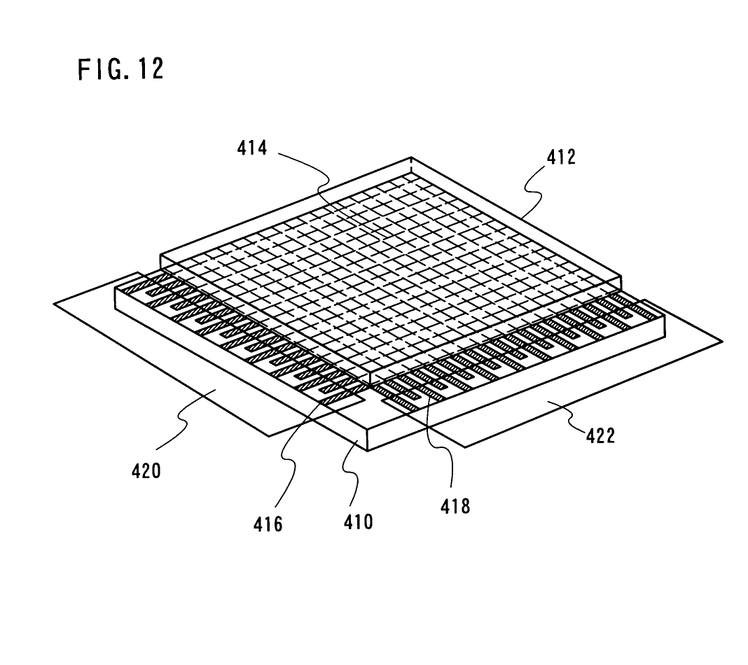

In this embodiment mode, a display device as one mode of the light-emitting device will be explained with reference to FIGS. 12 to 15B. FIG. 12 is a general configuration diagram showing a main part of the display device.

In FIG. 12, over a substrate 410, a first electrode 416 and a second electrode 418 that extends in a direction intersecting with the first electrode 416 are provided. A light-emitting layer formed using an inorganic EL material formed by a manufacturing method of the present invention is provided at least at the intersection portion of the first electrode 416 and the second electrode 418, whereby a light-emitting element is formed. In a display device of FIG. 12, a plurality of first electrodes 416 and a plurality of second electrodes 418 are placed and light-emitting elements to be pixels are arranged in matrix, whereby a display portion 414 is formed. In the display portion 414, light emission and non-light emission of each light-emitting element are controlled by controlling potentials of the first electrode 416 and the second electrode 418. In this manner, the display portion 414 can display moving images and still images.

In this display device shown in FIG. 12, a signal for displaying an image is applied to each of the first electrode 416 extending in one direction over the substrate 410 and the second electrode 418 that intersects with the first electrode 416, and light emission and non-light emission of a light-emitting element are selected. In other words, this is a simple matrix display device of which the pixel is driven mostly by a signal given from an external circuit. A display device like this has a simple structure and can be manufactured easily even when the area is enlarged.

A counter substrate 412 may be provided as necessary, and it can serve as a protective material when provided to be adjusted to the position of the display portion 414. The protective material does not have to be a hard plate material; and a resin film or a resin material may be applied instead. The first electrode 416 and the second electrode 418 are led to end portions of the substrate 410 to form terminals to be connected to external circuits. In other words, the first electrode 416 and the second electrode 418 are connected to the first and second flexible wiring boards 420 and 422, and connected to an external circuit via a flexible printed board. The external circuits include a power supply circuit, a tuner circuit, or the like, in addition to a controller circuit that controls a video signal.

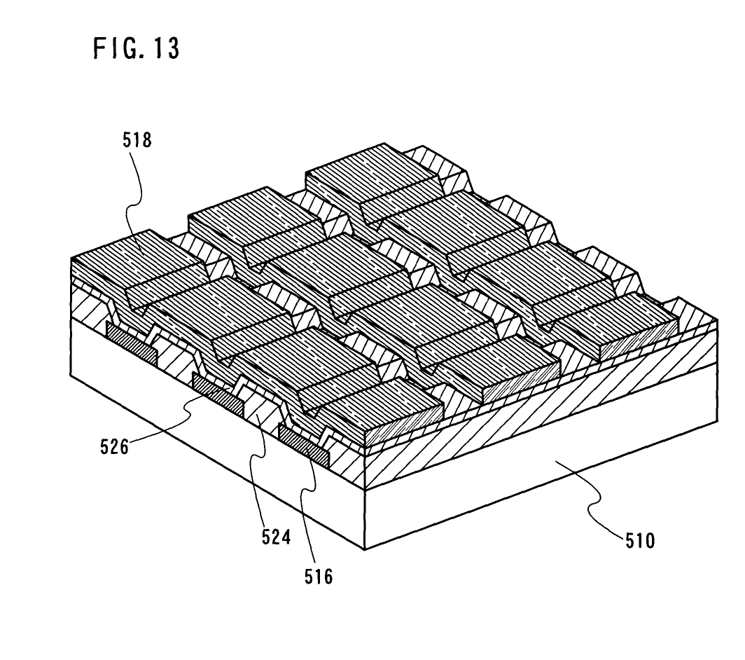

FIG. 13 is a partial enlarged view showing a structure of the display portion 414 in FIG. 12. A partition layer 524 is formed on an end portion of the first electrode 516 formed over the substrate 510. An EL layer 526 is formed at least over the first electrode 516. Here, the EL layer 526 includes at least a first dielectric layer, a second dielectric layer and a light-emitting layer formed between the first dielectric layer and the second dielectric layer, shown in Embodiment Mode 4. Alternatively, the EL layer 526 may include a single layer of a dielectric layer and the light-emitting layer shown in Embodiment Mode 4. Alternatively, the EL layer 526 may be a light-emitting layer having a stacked structure of a p-channel semiconductor layer and an n-channel semiconductor layer, not having a dielectric layer. A second electrode 518 is formed over the EL layer 526. The second electrode 518 intersects with the first electrode 516. The partition layer 524 is formed using an insulating material so that short-circuiting between the first electrode 516 and the second electrode 518 is prevented. In a portion where the partition layer 524 covers the end portion of the first electrode 516, an end portion of the partition layer 524 is sloped so as not to make a steep step, and has a so-called tapered shape. In the case where the partition layer 524 has such a shape, coverage of the EL layer 526 and the second electrode 518 improves, and defects such as cracks or tear can be prevented.

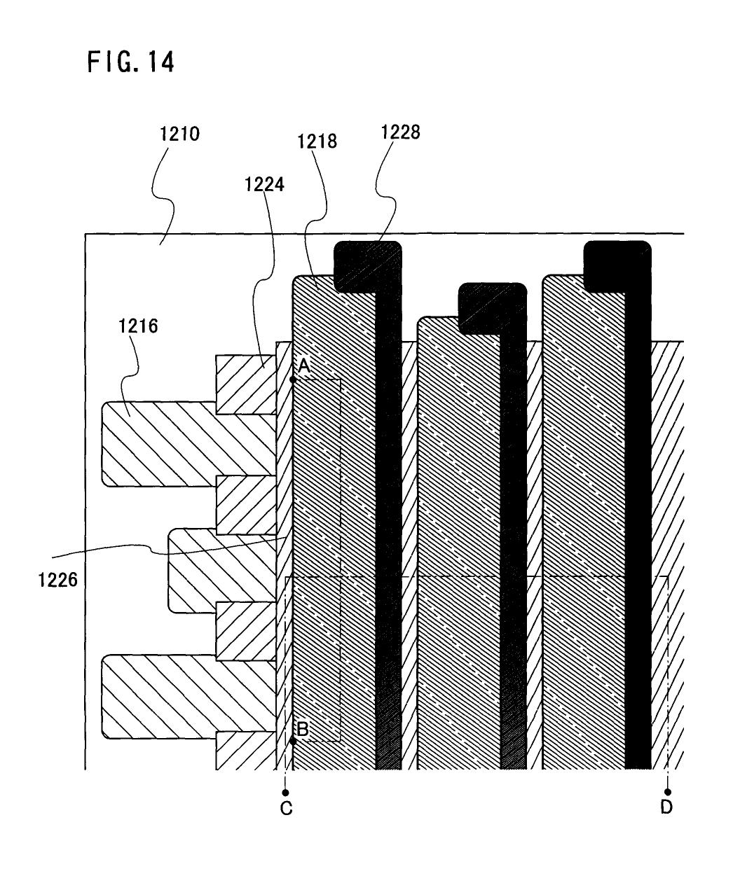

FIG. 14 is a plane view of the display portion 414 in FIG. 12, which shows the arrangement of a first electrode 1216, a second electrode 1218, a partition layer 1224, and an EL layer 1226 over a substrate 1210. In a case where the second electrode 1218 is formed of a transparent conductive oxide film having transparency of indium tin oxide, zinc oxide, or the like, an auxiliary electrode 1228 is preferably provided so as to reduce resistance loss. In this case, the auxiliary electrode 1228 may be formed using a refractory metal such as titanium, tungsten, chromium, or tantalum, or a combination of the refractory metal and a low resistance metal such as aluminum or silver.

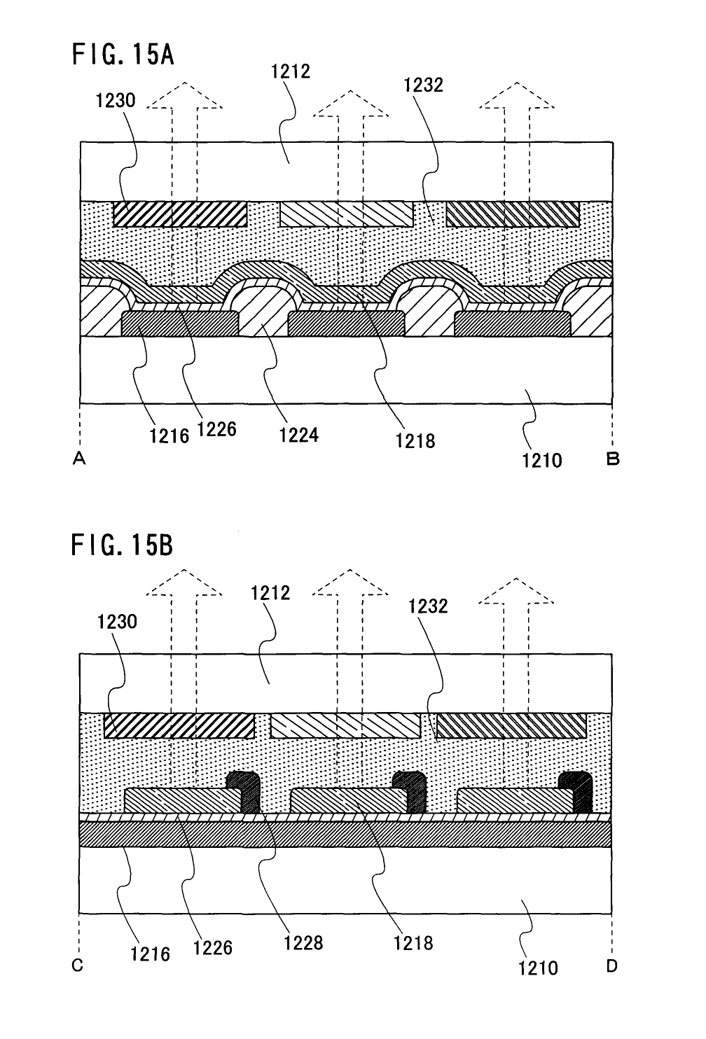

FIGS. 15A and 15B show cross-sectional views taken along a line A-B and a line C-D in FIG. 14, respectively. FIG. 15A is a cross-sectional view in which the first electrodes 416 in FIG. 13 are lined up, and FIG. 15B is a cross-sectional view in which the second electrodes 418 in FIG. 13 are lined up. The EL layer 1226 is formed at the intersection portions of the first electrode 1216 and the second electrode 1218 which are over the substrate 1210, and light-emitting elements are formed in these portions. An auxiliary electrode 1228 shown in FIG. 15B is provided over the partition layer 1224 and in contact with the second electrode 1218. The auxiliary electrode 1228 formed over the partition layer 1224 does not block light from the light-emitting element formed at the intersection portion of the first electrode 1216 and the second electrode 1218; therefore, the emitted light can be efficiently utilized. In addition, with this structure, short-circuiting between the auxiliary electrode 1228 and the first electrode 1216 can be prevented.

FIG. 15B shows an example in which a color conversion layer 1230 is placed on a counter substrate 1212. The color conversion layers 1230 convert the wavelength of light emitted from the EL layer 1226 so that the color of the light emission is changed. In this case, light emitted from the EL layer 1226 is preferably blue light or ultraviolet light with high energy. When the color conversion layers 1230 for converting light to red, green, and blue light are each arranged, a display device that performs RGB full-color display can be obtained. Furthermore, the color conversion layer 1230 can be replaced by a colored layer (color filter). In this case, the EL layer 1226 may be structured to emit white color light. A filler 1232 may be as appropriate provided so as to fix the substrate 1210 and the counter substrate 1212 to each other.

The light-emitting device shown in this embodiment mode can improve its emission luminance, emission efficiency, life time, since the light-emitting device uses an inorganic EL material with reduced unnecessary impurity in a base material. In the manufacturing process of an inorganic EL, since unnecessary impurities are not contained, a washing step can be omitted, and throughput of the light-emitting device formed using the inorganic EL material can be enhanced.

### EXAMPLE 1

Example 1 will specifically explain a manufacturing method of an inorganic EL material in accordance with the present invention with reference to FIG. 1A.

As shown in FIG. 1A, a case is explained, where a base material contained in a crucible and an atmosphere material contained in a crucible are disposed in a sealed tube. As the base material, a mixture of zinc sulfide (ZnS) and gallium arsenide (GaAs) is prepared and contained in the crucible. As the atmosphere material, aluminum sulfide (Al₂S₃) was contained in the crucible. At that time, if each material has a large diameter, each material is crushed by a crusher or the like so that its diameter can be made small. In addition, as the base material, ZnS and GaAs are mixed and are made sufficiently dispersed in each other.

The crucibles containing materials are disposed in a quartz tube and heated by a burner while being vacuumed to form a sealed tube. The thusly obtained sealed tube is baked in a tubular furnace having distribution of temperature. The boiling points of ZnS, GaAs and Al₂S₃ are about 1830° C., about 1240° C. and about 1550° C. respectively. Since the sulfur atmosphere is needed to be made by Al₂S₃, and ZnS having the highest boiling point is a base material, the atmosphere material is preferably in a low temperature portion. It is necessary that the vapor pressures of the respective materials are considered; however, it is necessary that the atmosphere material becomes a gas first to form a sulfur atmosphere. As the baking condition, a temperature of about 1200 to 1300° C. is preferable such that quartz does not react. In addition, the holding time at these temperatures are preferably about two to five hours. In this manner, Zinc Gallium Sulfide (ZnGa₂S₄) can be formed.

The atmosphere material and the base material are baked in discrete crucibles and thus, mixture of the atmosphere into the base material is believed to be prevented. However, since GaAs is used as the base material, washing is needed after the baking. Washing with pure water is conducted first, and then, washing with acetic acid (CH₃COOH) is conducted. Lastly, washing with pure water is conducted again to remove acetic acid (CH₃COOH) used in washing and dried. Drying is conducted at 100 to 200° C. for one to five hours while exhausting. In this manner, an inorganic EL material of the present invention can be obtained.

The inorganic EL material formed in this example can improve its emission luminance, emission efficiency, life time, since the inorganic EL material has reduced unnecessary impurity in the base material.

### EXAMPLE 2

Example 2 will specifically explain a manufacturing method of an inorganic EL material of the present invention with reference to FIG. 1A.

As a base material, zinc sulfide which is activated by copper (Cu) and chlorine (Cl)(ZnS:Cu, Cl) is used. The base material is contained in an alumina crucible and ammonium chloride (NH₄Cl) or potassium chloride (KCl) is contained in an alumina crucible as an atmosphere material similarly. The materials contained in the two crucibles are sealed in a quartz tube. The baking temperature is about 600 to 800° C. and the holding time is one to five hours. Ammonium chloride has a melting point of around 340° C. and a boiling point of around 520° C. Potassium chloride has a boiling point of around 775° C. In this example, the atmosphere material becomes gas at a temperature lower than the base material, and thus, the inside of the sealed tube becomes an atmosphere of the atmosphere material. The atmosphere material increases crystallinity of the base material, and when baking is conducted in a muffle furnace with temperature homogeneity, the crystallinity of the base material is increased in the crucible. When baking is conducted using a horizontal tubular furnace having distribution of temperature, the atmosphere material serves as a carrier gas, and as the base material, ZnS:Cu, Cl having good crystallinity or a single crystalline ZnS:Cu, Cl can be obtained at a lower temperature portion than the atmosphere material.

A single phase ZnS:Cu, Cl having good crystallinity can be obtained without containing the atmosphere material in the base material. Further, the washing step can be eliminated. By a manufacturing method of the present invention, a base material having good crystallinity or a single crystal base material can be obtained, and thus, the orientation is more improved than Zn:Cu, Cl baked in a conventional manner. As a result, emission luminance, emission efficiency and life time can be increased.

This application is based on Japanese Patent Application serial no. 2006-153228 filed in Japan Patent Office on Jun. 1, 2006, the entire contents of which are hereby incorporated by reference.

What is claimed is:

1. A method for manufacturing an electroluminescent material, comprising the steps of:
disposing a first material contained in a first crucible and a second material contained in a second crucible in a reaction container;
reducing pressure in the reaction container, the reaction container being sealed hermetically; and
baking the first material while the second material is evaporated by application of heat to the reaction container that is hermetically sealed.

2. A method for manufacturing an electroluminescent material according to claim 1,
wherein the second material includes an impurity that is to be unnecessary after baking, and the first material is baked while the second material is evaporated by application of heat to the reaction container that is sealed hermetically, and
wherein a third material of which impurity concentration is lower than impurity concentration of the second material is formed in a position different from the first material and the second material in the reaction container.

3. A method for manufacturing an electroluminescent material according to claim 2,
wherein the third material is single crystal.

4. A method for manufacturing an electroluminescent material according to claim 2,
wherein a single crystalline substance is located in a position where the third material is formed in the reaction container.

5. A method for manufacturing an electroluminescent material according to claim 1,
wherein the second material is a compound including an element selected from Group 15, 16, or 17 of the periodic table.

6. A method for manufacturing an electroluminescent material according to claim 1,
wherein an atmosphere of the reaction container that is sealed hermetically before baking is of a vacuum or of an inert gas.

7. A method for manufacturing an electroluminescent material according to claim 1,
wherein the first material and the second material are separately contained in the reaction container.

8. A method for manufacturing an electroluminescent material according to claim 1,
wherein each of the first material and the second material is an inorganic substance.

9. A light-emitting element, wherein the electroluminescent material manufactured in claim 1 is used.

10. A light emitting device, wherein a light-emitting element using the electroluminescent material that is manufactured in claim 1 is included.

11. A light-emitting device, wherein the light-emitting device according to claim 10 is a lighting apparatus.

12. An electronic device, wherein the light-emitting device according to claim 11 is used for a display portion.

13. A method for manufacturing an electroluminescent material, comprising the steps of:
disposing a first material in a first region of a reaction container and a second material in a second region of the reaction container, the first region and the second region being separated by an orifice;
reducing pressure in the reaction container, the reaction container being sealed hermetically; and
baking the first material while the second material is evaporated by application of heat to the reaction container that is sealed hermetically.

14. A method for manufacturing an electroluminescent material according to claim 13,
wherein the first material is contained in a first crucible, and the second material is contained in a second crucible.

15. A method for manufacturing an electroluminescent material according to claim 13,
wherein the second material includes an impurity that is to be unnecessary after baking, and the first material is baked while the second material is evaporated by application of heat to the reaction container that is sealed hermetically, and
wherein a third material of which impurity concentration is lower than impurity concentration of the second material is formed in a position different from the first material and the second material in the reaction container.

16. A method for manufacturing an electroluminescent material according to claim 15,
wherein the third material is single crystal.

17. A method for manufacturing an electroluminescent material according to claim 15,
wherein a single crystalline substance is located in a position where the third material is formed in the reaction container.

18. A method for manufacturing an electroluminescent material according to claim 13,
wherein the second material is a compound including an element selected from Group 15, 16, or 17 of the periodic table.

19. A method for manufacturing an electroluminescent material according to claim 13,
wherein an atmosphere of the reaction container that is sealed hermetically before baking is of a vacuum or of an inert gas.

20. A method for manufacturing an electroluminescent material according to claim 13,
wherein the first material and the second material are separately contained in the reaction container.

21. A method for manufacturing an electroluminescent material according to claim 13,
wherein each of the first material and the second material is an inorganic substance.

22. A light-emitting element, wherein the electroluminescent material manufactured in claim 13 is used.

23. A light emitting device, wherein a light-emitting element using the electroluminescent material that is manufactured in claim 13 is included.

24. A light-emitting device, wherein the light-emitting device according to claim 23 is a lighting apparatus.

25. An electronic device, wherein the light-emitting device according to claim 24 is used for a display portion.

26. A method for manufacturing an electroluminescent material, comprising the steps of:
disposing a first material contained in a first crucible and a second material contained in a second crucible in a reaction container;
reducing pressure in the reaction container, the reaction container being sealed hermetically; and
baking the first material while the second material is evaporated by application of heat to the reaction container that is hermetically sealed,
wherein the first material has lower vapor pressure than the second material, and
wherein the second material is disposed at a lower-temperature portion than the first material in the reaction container.

27. A method for manufacturing an electroluminescent material according to claim 26,
wherein the second material includes an impurity that is to be unnecessary after baking, and the first material is baked while the second material is evaporated by application of heat to the reaction container that is sealed hermetically, and
wherein a third material of which impurity concentration is lower than impurity concentration of the second material is formed in a position different from the first material and the second material in the reaction container.

28. A method for manufacturing an electroluminescent material according to claim 27,
wherein the third material is single crystal.

29. A method for manufacturing an electroluminescent material according to claim 27,
wherein a single crystalline substance is located in a position where the third material is formed in the reaction container.

30. A method for manufacturing an electroluminescent material according to claim 26,
wherein the second material is a compound including an element selected from Group 15, 16, or 17 of the periodic table.

31. A method for manufacturing an electroluminescent material according to claim 26,
wherein an atmosphere of the reaction container that is sealed hermetically before baking is of a vacuum or of an inert gas.

32. A method for manufacturing an electroluminescent material according to claim 26,
wherein the first material and the second material are separately contained in the reaction container.

33. A method for manufacturing an electroluminescent material according to claim 26,
wherein each of the first material and the second material is an inorganic substance.

34. A light-emitting element, wherein the electroluminescent material manufactured in claim 26 is used.

35. A light emitting device, wherein a light-emitting element using the electroluminescent material that is manufactured in claim 26 is included.

36. A light-emitting device, wherein the light-emitting device according to claim 35 is a lighting apparatus.

37. An electronic device, wherein the light-emitting device according to claim 36 is used for a display portion.

38. A method for manufacturing an electroluminescent material, comprising the steps of:
disposing a first material in a first region of a reaction container and a second material in a second region of the reaction container, the first region and the second region being separated by an orifice;
reducing pressure in the reaction container, the reaction container being sealed hermetically; and
baking the first material while the second material is evaporated by application of heat to the reaction container that is sealed hermetically,
wherein the first material has lower vapor pressure than the second material, and
wherein the second material is disposed at a lower-temperature portion than the first material in the reaction container.

39. A method for manufacturing an electroluminescent material according to claim 38,
wherein the first material is contained in a first crucible, and the second material is contained in a second crucible.

40. A method for manufacturing an electroluminescent material according to claim 38,
wherein the second material includes an impurity that is to be unnecessary after baking, and the first material is baked while the second material is evaporated by application of heat to the reaction container that is sealed hermetically, and
wherein a third material of which impurity concentration is lower than impurity concentration of the second material is formed in a position different from the first material and the second material in the reaction container.

41. A method for manufacturing an electroluminescent material according to claim 40,
wherein the third material is single crystal.

42. A method for manufacturing an electroluminescent material according to claim 40,
wherein a single crystalline substance is located in a position where the third material is formed in the reaction container.

43. A method for manufacturing an electroluminescent material according to claim 38,
wherein the second material is a compound including an element selected from Group 15, 16, or 17 of the periodic table.

44. A method for manufacturing an electroluminescent material according to claim 38,
wherein an atmosphere of the reaction container that is sealed hermetically before baking is of a vacuum or of an inert gas.

45. A method for manufacturing an electroluminescent material according to claim 38,
wherein the first material and the second material are separately contained in the reaction container.

46. A method for manufacturing an electroluminescent material according to claim 38,
wherein each of the first material and the second material is an inorganic substance.

47. A light-emitting element, wherein the electroluminescent material manufactured in claim 38 is used.

48. A light emitting device, wherein a light-emitting element using the electroluminescent material that is manufactured in claim 38 is included.

49. A light-emitting device, wherein the light-emitting device according to claim 48 is a lighting apparatus.

50. An electronic device, wherein the light-emitting device according to claim 49 is used for a display portion.

51. A method for manufacturing an electroluminescent material, comprising the steps of:
disposing a first material contained in a first crucible and a second material contained in a second crucible in a reaction container;
reducing pressure in the reaction container, the reaction container being sealed hermetically; and
baking the first material while the second material is evaporated by application of heat to the reaction container that is hermetically sealed,
wherein the first material has higher vapor pressure than the second material, and
wherein the second material is disposed at a higher-temperature portion than the first material in the reaction container.

52. A method for manufacturing an electroluminescent material according to claim 51,
wherein the second material includes an impurity that is to be unnecessary after baking, and the first material is baked while the second material is evaporated by application of heat to the reaction container that is sealed hermetically, and
wherein a third material of which impurity concentration is lower than impurity concentration of the second material is formed in a position different from the first material and the second material in the reaction container.

53. A method for manufacturing an electroluminescent material according to claim 52,
wherein the third material is single crystal.

54. A method for manufacturing an electroluminescent material according to claim 52,
wherein a single crystalline substance is located in a position where the third material is formed in the reaction container.

55. A method for manufacturing an electroluminescent material according to claim 51,
wherein the second material is a compound including an element selected from Group 15, 16, or 17 of the periodic table.

56. A method for manufacturing an electroluminescent material according to claim 51,
wherein an atmosphere of the reaction container that is sealed hermetically before baking is of a vacuum or of an inert gas.

57. A method for manufacturing an electroluminescent material according to claim 51,
wherein the first material and the second material are separately contained in the reaction container.

58. A method for manufacturing an electroluminescent material according to claim 51,
wherein each of the first material and the second material is an inorganic substance.

59. A light-emitting element, wherein the electroluminescent material manufactured in claim 51 is used.

60. A light emitting device, wherein a light-emitting element using the electroluminescent material that is manufactured in claim 51 is included.

61. A light-emitting device, wherein the light-emitting device according to claim 60 is a lighting apparatus.

62. An electronic device, wherein the light-emitting device according to claim 61 is used for a display portion.

63. A method for manufacturing an electroluminescent material, comprising the steps of:
disposing a first material in a first region of a reaction container and a second material in a second region of the reaction container, the first region and the second region being separated by an orifice;
reducing pressure in the reaction container, the reaction container being sealed hermetically; and
baking the first material while the second material is evaporated by application of heat to the reaction container that is sealed hermetically, wherein the first material has higher vapor pressure than the second material, and
wherein the second material is disposed at a higher-temperature portion than the first material in the reaction container.

64. A method for manufacturing an electroluminescent material according to claim 63,
wherein the first material is contained in a first crucible, and the second material is contained in a second crucible.

65. A method for manufacturing an electroluminescent material according to claim 63,
wherein the second material includes an impurity that is to be unnecessary after baking, and the first material is baked while the second material is evaporated by application of heat to the reaction container that is sealed hermetically, and
wherein a third material of which impurity concentration is lower than impurity concentration of the second material is formed in a position different from the first material and the second material in the reaction container.

66. A method for manufacturing an electroluminescent material according to claim 65,
wherein the third material is single crystal.

67. A method for manufacturing an electroluminescent material according to claim 65,
wherein a single crystalline substance is located in a position where the third material is formed in the reaction container.

68. A method for manufacturing an electroluminescent material according to claim 63,
wherein the second material is a compound including an element selected from Group 15, 16, or 17 of the periodic table.

69. A method for manufacturing an electroluminescent material according to claim 63,
wherein an atmosphere of the reaction container that is sealed hermetically before baking is of a vacuum or of an inert gas.

70. A method for manufacturing an electroluminescent material according to claim 63,
wherein the first material and the second material are separately contained in the reaction container.

71. A method for manufacturing an electroluminescent material according to claim 63,
wherein each of the first material and the second material is an inorganic substance.

72. A light-emitting element, wherein the electroluminescent material manufactured in claim 63 is used.

73. A light emitting device, wherein a light-emitting element using the electroluminescent material that is manufactured in claim 63 is included.

74. A light-emitting device, wherein the light-emitting device according to claim 73 is a lighting apparatus.

75. An electronic device, wherein the light-emitting device according to claim 74 is used for a display portion.
